(19) United States
(12) Patent Application Publication
(10) Pub. No.: US 2020/0342399 A1
(43) Pub. Date: Oct. 29, 2020

(54) MULTI-PLATFORM ELECTRONIC DOCUMENT MANAGEMENT SYSTEM FOR DISTRIBUTED ENVIRONMENT

(71) Applicants: John Keith Koppinger, III, Ann Arbor, MI (US); Robert Domenic Forte, Plymouth, MI (US)

(72) Inventors: John Keith Koppinger, III, Ann Arbor, MI (US); Robert Domenic Forte, Plymouth, MI (US)

(21) Appl. No.: 16/397,011

(22) Filed: Apr. 29, 2019

(51) Int. Cl. G06Q 10/08; G06F 16/93; G06Q 30/00

(52) U.S. Cl. CPC G06Q 10/0838; G06Q 30/018; G06F 16/93

(57) ABSTRACT

Methods, systems, and computer programs are presented for implementing a paperless bill of lading (BOL) end-to-end system. One method includes an operation for receiving document data exported by a first device associated with a first user, where the document data includes freight information and identification of a second user for transporting the freight. Further, the method includes operations for validating that the second user is allowed to transport the freight, and, after the validating, sending the document data to a second device, associated with the second user, via an app executing on the second device. Additionally, a request is received to validate information obtained by a third device of the first user, the information being provided by the app executing on the second device. The method further includes validating the information provided by the app and causing presentation of the document data in the third device.

### TECHNICAL FIELD

The subject matter disclosed herein generally relates to methods, systems, and machine-readable storage media for electronic document management in a system with mobile devices.

### BACKGROUND

A Bill of Lading (BOL) is a document that represents the legal transfer of a title of goods from a shipper to a carrier to a receiver, also known as the consignee. An estimated $420 billion is spent every year worldwide handling physical BOLs, which is about 5% of total worldwide logistics expenses.

Legal records of signed and executed BOLs must be kept for several years after a delivery is made in order to resolve not only possible cargo disputes with carriers, but also trade disputes that may arise between suppliers and customers. The requirement for longtime storage adds even more cost to the handling of the initial BOL, which requires that several paper copies are printed for the different parties: shipper, driver, carrier, consignee, etc.

### BRIEF DESCRIPTION OF THE DRAWINGS

Various ones of the appended drawings merely illustrate example embodiments of the present disclosure and cannot be considered as limiting its scope.

FIG. 1 is a flowchart of a method for management of paper bill of lading (BOL), according to some example embodiments.

FIG. 2A illustrates an architecture for an electronic document management system, according to some example embodiments.

FIG. 2B illustrates the load acceptance flow, according to some example embodiments.

FIGS. 3-8 illustrate the flow of information and the events associated with the electronic document management system, according to some example embodiments.

FIG. 9A illustrates the structure of the data store, according to some example embodiments.

FIG. 9B illustrates the customization of the BOL for a particular shipper, according to some example embodiments.

FIG. 9C illustrates the processing of BOL data for the shipper, according to some example embodiments.

FIGS. 10A-20B show user interfaces provided by the electronic document management system, according to some example embodiments.

FIG. 21 is a system architecture for the electronic document management system, according to some example embodiments.

FIG. 22 is a flowchart of a method for implementing a paperless bill of lading (BOL) end-to-end system, according to some example embodiments.

FIG. 23 is a flowchart of a method for managing the storage of documents, according to some example embodiments.

FIG. 24 is a block diagram illustrating an example of a machine upon or by which one or more example process embodiments described herein may be implemented or controlled.

### DETAILED DESCRIPTION

Example methods, systems, and computer programs are directed to an electronic document management system. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A system architecture is presented for an electronic document management, and in particular, management of a bill of lading (BOL). The disclosed system eliminates having to print BOLs in order to transfer ownership of a load to be transported. A BOL manager includes a server that communicates with shippers, dispatchers, drivers, and load recipients to update and present the information of the BOL. Graphical user interfaces (GUI) are provided to the different entities in order to track one or more BOLs. A mobile application is available for drivers, and the different entities may sign using the application on a mobile device or with their own interfaces to the BOL manager. The mobile application includes all the BOL information and may be presented to authorities upon request. Updates to the status of the BOL are made available to the different entities in practically real time, thereby facilitating the tracking of loads as well as the integration of the BOL information with other systems, such as Enterprise Resource Management (ERP) and Transportation Management System (TMS), which simplifies information consistency and updating, such as BOL initialization and BOL-update reconciliation.

The BOL manager includes an open Application Programming Interface (API) to exchange information with other systems, such as ERP and TMS, from both shippers and consignees. The BOL management system lowers the costs of freight expenses. Additionally, the BOL management system provides the benefits of automatically tracking freight via the driver mobile application, capturing data easily at all stages of freight movement, maintaining accurate records and attention, reducing the amount of effort required to audit freight information, reducing the amount of effort required for billing reconciliation, reducing the amount of detention of drivers waiting for shipments to be loaded, automating carrier payments, centralizing documentation, and providing full freight visibility throughout the whole shipment process.

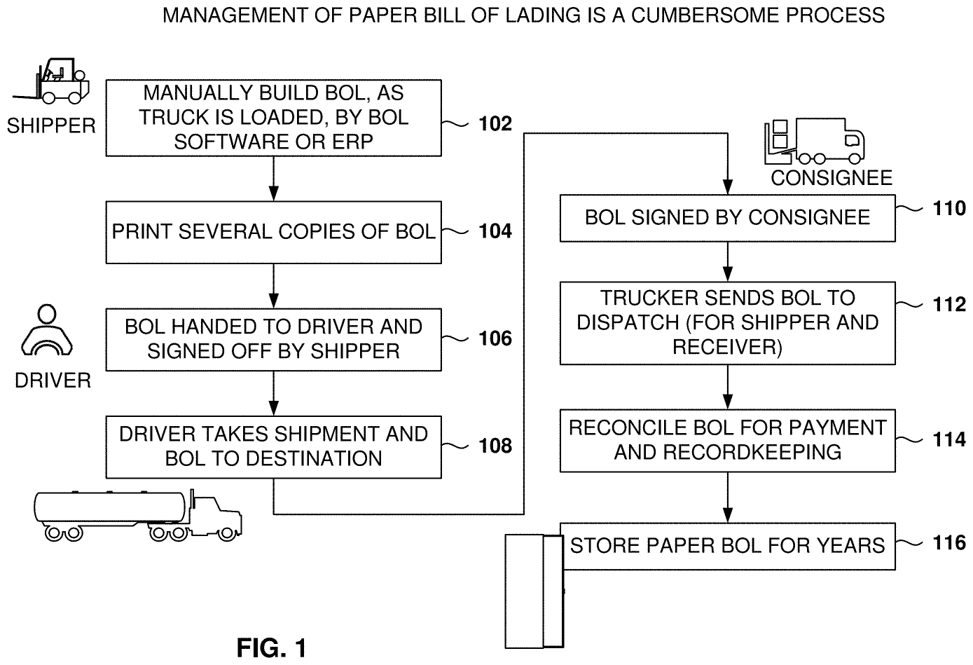

FIG. 1 is a flowchart of a method for management of paper bills of lading (BOL), according to some example embodiments. The process of managing paper BOLs is cumbersome and expensive. FIG. 1 illustrates a sample process for managing a shipment when using a paper BOL.

At operation 102, the BOL is typically initiated manually or by an ERP, TMS or BOL software. When initiated manually, there is a chance of human error and some mistake in the data entry. Further, there could be discrepancies between the data entered manually in the ERP and the BOL software.

At operation 104, several copies of the BOL are printed, sometimes on multi-ply paper and other times by making multiple copies on a printer, which increases the time to print the BOL. Printing costs add to the cost of shipping freight. Further, workers have to leave the shop floor sometimes to go find the printouts by the printer.

Afterwards, at operation 106, the BOL is signed off by the shipper and handed to the driver. At this stage, there could be a mistake with the wrong BOL being handed to the driver, or, if the carrier provides their own BOL, errors and omissions may arise because the original data was not created by the shipper.

Afterwards, the driver takes control and, at operation 108, the driver takes the BOL with the shipment to the destination. Some of the issues at this stage include signature and time forgeries, changing BOL information after mistakes are identified, loss of BOL by the driver, and changes to the BOL that are untracked, such as re-weight, re-seal, etc.

At operation 110, the BOL, presented by the driver, is signed by the consignee at the drop point. At this stage, some of the potential problems include signature and time forgeries and disagreements over the condition of the delivered goods.

Afterwards, at operation 112, the driver sends the BOL to the dispatcher, which may forward the BOL to the shipper and receiver. The issues here include forgeries as before, changing facts, or that it may take days or weeks to receive the paperwork.

After the shipment is completed, at operation 114 the BOL is reconciled (by the shipper, or the consignee) for payment and record-keeping. The issues at this stage include possible mistakes made by manually verifying the details of the BOL; potential mistakes due to increased papers or poor handwriting; faxed, scanned, or photo BOLs may be illegible; and any changes or exceptions have to be manually reconciled in the ERP and accounting systems.

Further, at operation 116, the paper BOL has to be stored for several years for record-keeping and possible audits. The means allocating resources for the long-term storing of the BOLs.

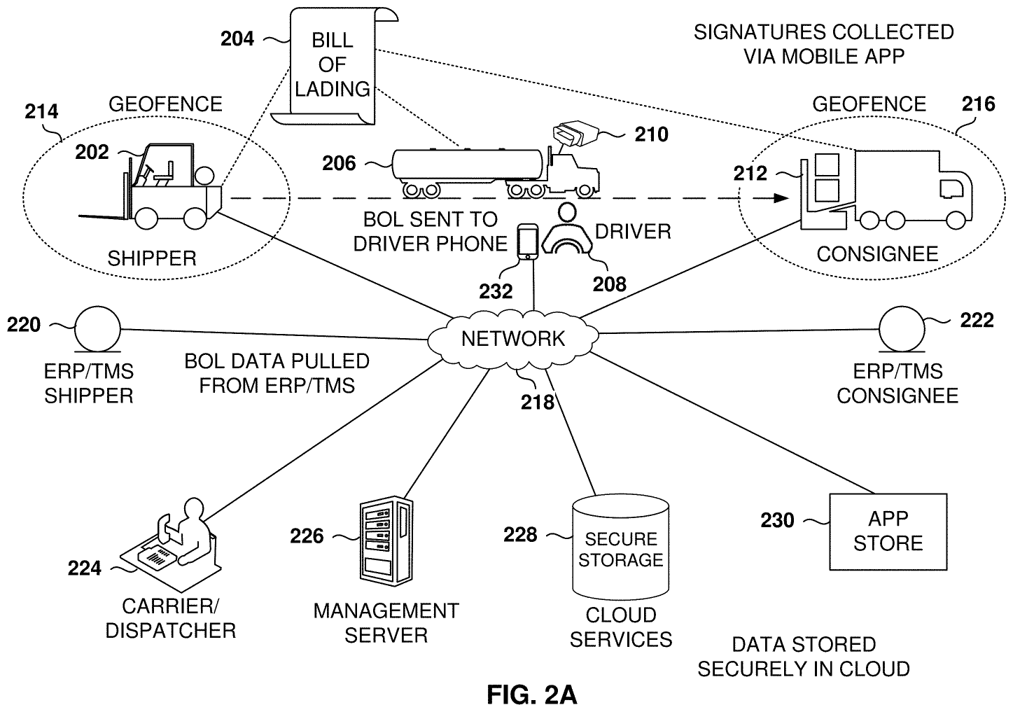

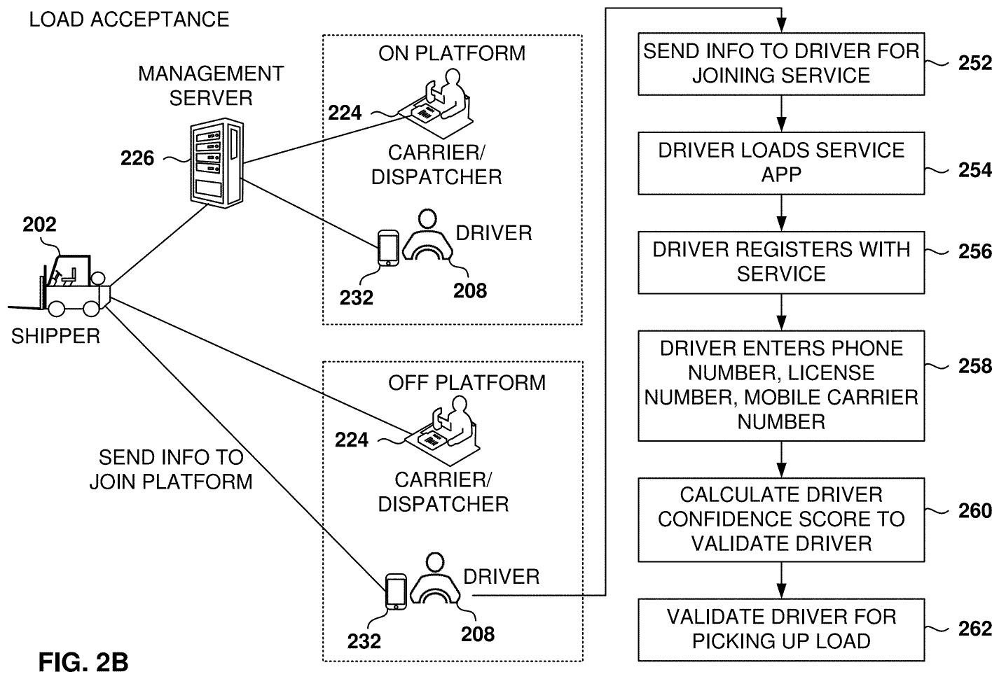

FIG. 2A illustrates an architecture for an electronic document management system, according to some example embodiments. The BOL management system solves some of the problems discussed above and reduces the costs associated with document management, particularly the high cost of printing BOLs.

The architecture includes a management server 226, a shipper 202, a driver 208 with a mobile device 232, a consignee 212, an ERP/TMS 220 from the shipper 202, an ERP/TMS 222 from the consignee 212, a dispatcher 224 from a carrier, secure storage 228, and one or more app stores 230 for downloading a mobile app.

The management server 226 is part of the BOL management system and coordinates the management of the BOL 204 from its creation to modifications made, tracking, reconciliation, and long-term storage.

A network 218 is used to interconnect the different entities. The network 218 may include one or more telecommunications media, such as different Internet providers, different mobile phone providers, etc.

In general, ERP is business process management software that allows an organization to use a system of integrated applications to manage the business and automate many back-office functions related to technology, services, and human resources. Typically, ERP software integrates all facets of an operation (including product planning, development, manufacturing, sales and marketing) in a single database, application, and user interface.

Further, TMS is a platform designed to streamline the shipping process and is a part of the supply-chain management for transportation solutions. The TMS allows shippers to automate their processes and receive valuable insights to save time and reduce spending on future shipments.

In some example embodiments, information for creating the BOL 204 is pulled from the ERP/TMS 220, ERP/TMS 222, or both. In some example embodiments, data for the BOL 204 may also be entered manually or imported from BOL software (not shown).

After the BOL 204 is created, the information is made available by the management server 226 to all the associated entities (e.g., shipper 202, dispatcher 224, driver 208, consignee 212). The BOL management system is designed for collaboration amongst parties of a given shipment, including the concept of a guest user, who is authenticated and identified, but not necessarily a user in the system itself. The BOL management interfaces are available in several platforms, such as the BOL management web platform, the BOL driver mobile app (e.g., available in iOS™ and Android™), the BOL shipper mobile app (e.g., available in iOS™ and Android™), and the BOL carrier web app, etc.

The shipper 202 creates a shipment and then that BOL 204 is created, sometimes by pulling information from the ERP/TMS 220, or the BOL 204 may be created on the BOL management service. A snapshot of the BOL 204 is created and stored in the management server 226, and the information for the shipment is available to the different entities associated with the shipment.

The shipper 202 then finds a carrier for that shipment, which can be done through their network of carriers and brokers or can be facilitated by the BOL management service. A carrier can directly accept the shipment via BOL carrier web app, the BOL driver mobile app, or by other communications method, such as phone, email, texting, etc.

If the carrier is found outside of the BOL management platform, the carrier is assigned to the shipment via the BOL management system directly or via the shipper's ERP/TMS 220 and pushed in real-time to the BOL management system. After this assignment, the BOL management system emails the carrier's dispatcher 224 directly with the shipment tender, where they will be asked to provide their preferences around the shipment (appointment times, etc.), and also with the driver's phone number that will be assigned to the shipment. If the driver's phone number is not available, the number is requested again later. If the carrier is found via the BOL management carrier web platform, then upon acceptance by the dispatcher 224, the same flow occurs above where the carrier's dispatcher 224 is required to enter the driver's phone number. Upon receipt of actual driver's phone number, driver 208 is texted a link to download the BOL driver app. If the driver 208 for the shipment accepts via the BOL management carrier mobile app executing on mobile device 232, then the driver 208 is already assigned to the shipment and no further action is required.

The driver 208 then picks up the shipment at the shipper's location. Entry by the truck 206 driven by driver 208 on a geofence 214 may be detected by tracking the driver's GPS by the BOL driver mobile app. Similarly, the geofence 216 around the consignee 212 may be detected when the truck 206 approaches the destination. Detecting when the truck 206 breaches the geofences 214, 216 is useful to alert the different parties when the driver 208 is close to the shipper 202 or the consignee 212.

The BOL management service improves operation efficiency because signatures are collected via electronic devices, such as the BOL driver app, and stored securely on the secure storage 228. Additionally, all the data for the BOL 204 is also stored in the secure storage 228, including possible different versions of the BOL 204 as modifications are made through the process.

The BOL management service keeps track of when trucks actually arrive and leave a facility, and generates status updates throughout the cargo transfer, such as pickup time, delivery time, etc. By doing all these activities electronically, significant cost savings are achieved, especially by the shipper 202, who does not have to manually create and track the BOL 204. The driver 208 and the carrier also save money because the BOL 204 information is handled electronically, without having to communicate by phone, fax, emails, etc.

If a police officer stops the truck 206 and requests information about the shipment, the BOL data may be shown on the mobile device 232. Also, if the driver 208 has to stop at a weight station, the electronic BOL may be shown to show proof of the contents of the shipment.

In some example embodiments, the BOL management service interfaces with an Electronic Logging Device (ELD) 210 in order to make the BOL available on the ELD interface. This makes the BOL viewable by other parties such as the dispatcher, law enforcement, customs agents, shipper, receiver or anybody else with the required authentication information. Viewers are authenticated by GPS location proximity to the current driver location and driver route.

The BOL management system solves some of the issues identified above with reference to the paper BOL processes, as described above with reference to FIG. 1. The BOL management system decreases the amount of mistakes because the data for the BOL is pulled directly from the ERP for the TMS systems. Further, the BOL management system eliminates the need of printing the BOL, thus reducing printing costs, with estimated savings in the range of 3% to 4% of the total shipment cost, though different systems may benefit from lower or greater savings. Further yet, one single BOL is administered for the whole system and for all the entities.

In addition, all changes to the BOL are recorded with timestamps, and the different versions of the BOL are saved. The full assigned version of the BOL is available to all parties immediately after the sign-up of the BOL. Further yet, all copies of the BOL are electronically recorded and saved on safe cloud storage, which eliminates the need of paper scanning. Additionally, changes to the BOL may be pushed to the ERP systems without manual interference.

FIG. 2B illustrates the load acceptance flow, according to some example embodiments. After shipment and the corresponding BOL are created, the shipper has to find a truck to move the merchandise. In some cases, both the shipper 202 and the carrier are subscribed to the BOL management service, which is referred to as being on a platform. The carrier may be a company with several trucks and a dispatcher 224 or a driver 208.

In other cases, the carrier is not subscribed to the BOL management system; that is, the carrier is off platform. As before, the carrier may be a company or an owner operator, and the driver 208 may be part of the company or own her own truck.

In the case when the carrier is on platform, the interaction is easy: the shipment may be accepted through the BOL management service and the driver 208 is notified of the shipment. The BOL management service provides the information associated with the shipment, such as pickup location, pickup time, etc.

On the BOL management services web application, after the dispatcher 224 or the driver 208 accepts the load, the BOL interface asks for the driver's phone number. If the driver 208 is an owner operator, the driver 208 enters her own phone number. Upon load acceptance within BOL management services mobile application, the BOL is made available upon geofence breach at pick-up location.

When the driver 208 is off platform, information about the carrier is either entered by shipper 202 into the BOL application GUI or obtained via TMS/ERP or other outside system integration. Further, the BOL manager performs an operation referred to as the tender, where a link is provided to the driver (e.g., via email). At operation 252, the BOL manager sends information (e.g., a URL for a webpage) to the driver 208 for accepting the load via the BOL management service. The driver 208 then opens that link on a browser and the webpage will show load information and a request for the driver's phone number. After the driver 208 provides the phone number, the driver 208 can then accept the load.

Further, the BOL manager invites the driver 208 to sign up for the BOL management service. The BOL manager sends the driver 208 a text message requesting that they upload the BOL driver app to their mobile device 232, the text message including a multi-functional link to download the app from the app store associated with the device's OS platform.

The link takes the driver 208 to a page that deciphers whether the app is already downloaded on their device 232, and if so, whether the user is logged in. If the app is downloaded and the user is logged in, selecting the link will take the app to the Live-Shipments page, which shows the assigned shipments to the driver 208. At this point, the BOL 204 may not have been created yet as the Live-Shipments page has shipment information on it.

If the driver 208 has the app, has a login, but is not logged in, selecting the received link takes the driver 208 to the sign-in page on the BOL website. If the driver 208 has the app, but does not have a login yet, selecting the link takes the driver 208 to the sign-up page. If the driver 208 does not have the app downloaded, then the driver 208 is directed to the adequate site for downloading the app (e.g., Apple Store or Google Play Store). Once the app is downloaded, the user is requested to sign up, but this is not a requirement in some cases.

At operation 254, the driver 208 loads the BOL driver app into the mobile device 232. At operation 256, the driver 208 registers with the BOL management service via the downloaded app. The driver 208 has to log in with an existing password or create a new account and a corresponding address.

At operation 258, the driver 208 enters, using the BOL driver app, the phone number, the license number of the truck, and the mobile carrier number, which is a unique identifier for the carrier.

Operation 260, a driver confidence score is calculated to validate the driver 208. The driver confidence score is based on whether the information provided by the driver 208 matches the information on-file provided by the carrier. If there is a match, then there is a high likelihood that this person that has downloaded the app, and entered this information, is the correct assigned driver 208.

Further, the driver confidence score provides an additional security check by using the GPS location information for the driver 208. The BOL driver app requests access to the GPS information from the mobile device 232. The location information of the driver 208 is then used to compare to the pick-up location and determine if the location is reasonable. For example, if a driver in California is expected to pick up a load in Arkansas in 12 hours, then the driver will not be able to make that pickup time. This inference will be used to deduce that this driver is not the right person for the pickup.

Further yet, the driver confidence score also checks the Internet Protocol (IP) address used by the mobile device 232, which is also analyzed for consistency when compared to the GPS location. For example, if the IP address on the device belongs to an IP address in Ontario, Canada, and the pickup is in California, then there's probably some mistake or malicious activity. The BOL manager will then generate an alert for the entities involved in this load transfer.

An additional test for the driver confidence score also includes checking the direction in which the driver is traveling, calculated based on the GPS information. If the driver is not going in the right direction to the pickup location, an alarm will be generated because this is probably not the right driver.

If the checks for the driver confidence score are passed, then the driver 208 is validated, at operation 262, for picking up the load. Additionally, the BOL 204 is not released until the driver 208 reaches the pickup geofence. For example, the GPS may be set at a quarter mile from the pickup location, but other distances may be used, such as in the range from 0.1 to 50 miles or more, depending on the preferences of the shipper 202. The bigger the geofence 214, the more advance warning the shipper 202 will receive that the driver 208 is approaching.

If there is an error produced by any of the factors of authentication, the user indicated by the phone number will be removed from the shipment as the “driver” and a “driver error” flag will be placed on the shipment in question. In this instance, the BOL management system will send periodic requests to the dispatcher 224 via email to provide the correct phone number. The email will have a link to a modal that will request that information. Each time the information is entered, a text will go out to the phone number provided requesting an app download until the system is able to verify the correct driver based on the driver confidence score.

If all goes wrong, and the driver is not able to accept the load via the BOL driver app, the BOL manager prints the BOL for the shipper so the load may be processed.

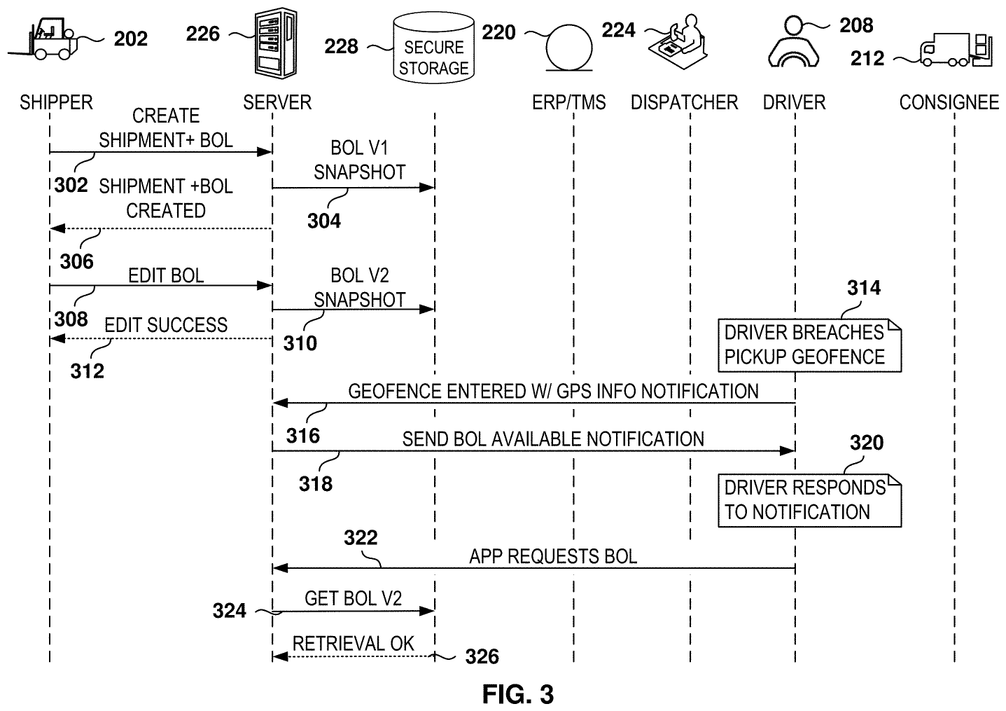

FIGS. 3-8 illustrate the flow of information and the events associated with the electronic document management system, according to some example embodiments. While the various operations in this flowchart are presented and described sequentially, one of ordinary skill will appreciate that some or all of the operations may be executed in a different order, be combined or omitted, or be executed in parallel.

At operation 302 in FIG. 3, the shipment and the BOL 204 are created by the shipper and the information transmitted to the management server 226. The information may be transferred via data entry on the BOL GUI or transmitted electronically from the ERP/TMS system (e.g., via API integration with the BOL management service). At this point, the BOL 204 is made available to the shipper in the BOL management platform.

In some example embodiments, the ERP/TMS 220 includes an API for obtaining data, and the API is used by the BOL manager to get the shipment data for creating the BOL.

In some example embodiments, the BOL 204 is only accessible at this time by the shipper, as the shipper has the details associated with the shipment. However, some things may change and the shipper may edit the BOL data. Further, for security reasons, the information is not shared until a decision is made to share the BOL 204 with the driver 208 or the dispatcher 224.

At operation 304, the initial version of the BOL, referred to as version BOL V1, is safely stored in secure storage 228, such as in storage provided by a cloud service, a blockchain, or in any other type of storage used by the management server 226. A confirmation 306, that the BOL was created, is sent from the management server 226 to the shipper 202.

The BOL manager keeps track of the different versions of the BOL, and each version is made available for retrieval. The data in the BOL may change over time, such as changes to the number of items being shipped, the destination, etc. Because there are no paper BOLs, all these versions must be stored and kept in case they are needed for auditing or settlement purposes. The different versions are immutable because they cannot be changed; if a change is made, a new version is created. This will help with any problems regarding contract interpretation associated with the BOL.

In some example embodiments, each version of the BOL is stored in a PDF file, but other formats may also be used (e.g., binary data for the fields that populate the BOL). In addition, a hash of the version of the BOL (e.g., a hash of the PDF file) is created and stored with the version of the BOL. The hash may be used to guarantee that the version of the BOL has not been changed, because any change to the BOL would result in a different hash of the version of the BOL.

When the time comes to access a version of the BOL, the version of the BOL and the hash are retrieved. The hash of the version of the BOL is calculated and then compared to the hash value that was retrieved. If the versions match, then the BOL version is authenticated; otherwise, an error is flagged.

For example, after creating the BOL, the shipper decides to edit the BOL at operation 308. The BOL management server 226 generates version V2 of the BOL and stores version V2, in operation 310, in secure storage 228. Afterwards, a confirmation message 312, confirming that the edit to the BOL was successful, is sent to the shipper 202.

At operation 314, the driver 208 breaches the pickup geofence, which means that the driver is approaching the pickup location. If the driver has the BOL driver app downloaded and is associated with the shipment, then as the driver breaches the geofence around the pickup location, the BOL driver app sends a notification to the management server 226 that the geofence has been reached. Also, the current UPS is transmitted.

A notification is sent in operation 318 to the driver 208, via the BOL driver app, that the latest version of the BOL is available. in some embodiments, even if the driver has multiple shipments in the BOL management system, only the current BOL is available for viewing in an effort to avoid confusion or error, where the driver would access the wrong BOL. Further, if the consignee 212 is on the BOL management service, the BOL is also be made available to the consignee 212.

At operation 320, the driver responds to the notification that the BOL is available, such as by accessing the BOL with the BOL driver app. Further, at operation 322, the driver requests the BOL using the BOL driver app. The management server 226 retrieves (operation 324) the current BOL version from secure storage, unless the management server 226 has the current version cached in memory. The BOL V2 is retrieved at operation 326.

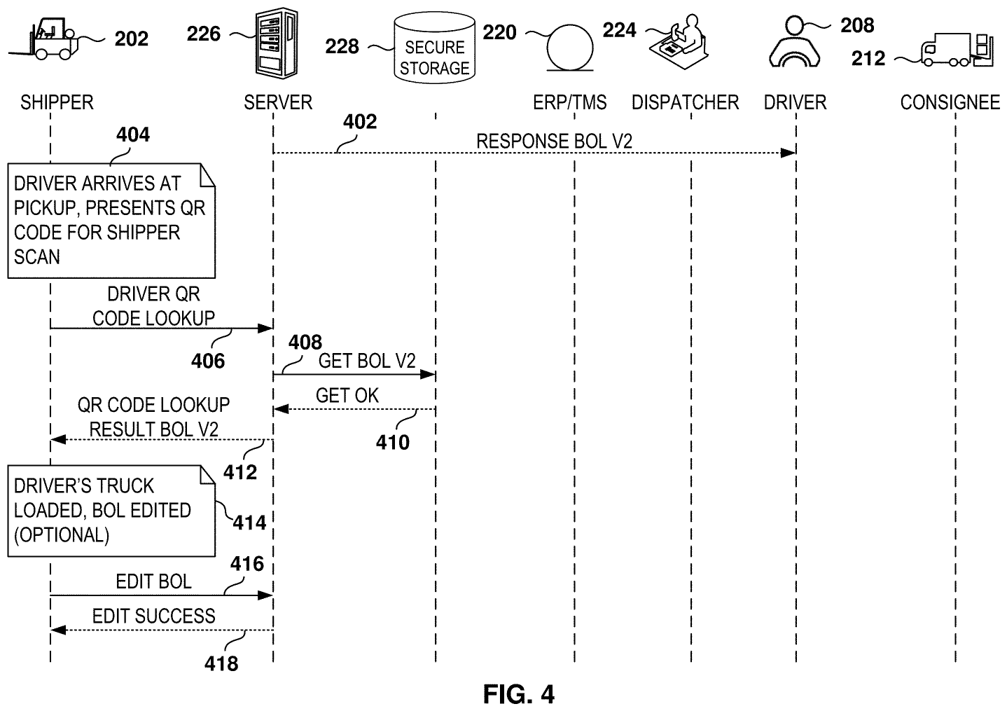

FIG. 4 shows the operations following the operations described with reference to FIG. 3. At operation 402, the management server 226 sends the current version of the BOL to the driver via the BOL driver app.

In some example embodiments, the BOL is not editable by the driver 208 with the exception of a “carrier exceptions” field. Similarly, the BOL is not editable by the consignee 212 except for a “delivery exceptions” field. In the carrier-exceptions field, the driver 208 can add information about the shipment, such as information that may not match the information on the BOL, such as the number of pallets, the weight of the load, the state of the merchandise, etc. If any information is entered in the carrier-exceptions field, the data is saved by the BOL manager and a new version of the BOL is created.

In the delivery-exceptions field, the consignee 212 may identify comments or problems associated with the freight delivered, such as wrong number of pallets, missing parts, wrong weight, late delivery, etc. This information is also saved by the management server 226 and a new version of the BOL may be created.

The BOL driver app makes available a unique identifier for the BOL that is visually recognizable, such as a Quick Response Code (QR code), a bar code, or some other graphical representation of the BOL. This unique identifier is scannable by the shipper to easily locate the BOL of that specific driver pick-up in the corresponding BOL management shipper app.

Upon arrival (404), the driver may present a pickup number, the QR code, or the bar code on their BOL driver app in order to allow the shipper to pull up the correct BOL in the system (which could be the BOL management web app, the BOL management shipper app, or their own system).

In some example embodiments, the shipper has the BOL shipper app to interact with the management server 226, and if the driver also has the BOL driver app, then driver and shipper can interact via the BOL management service.

The BOL shipper app scans the unique identifier (e.g., by taking a picture of the QR code) and sends (operation 406) the unique identifier to the management server 226. The management server 226 retrieves (operations 408, 410) the latest version of the BOL (e.g., V2), and sends (operation 412) the BOL to the shipper 202. The BOL shipper app will present the information of the BOL. This is very useful for shippers, because a shipper may have many BOLs open for different shipments (e.g., 50 shipments a day), and automatically showing the BOL, in response to capturing an image of the QR code, simplifies the work of the shipper because the shipper does not have to perform a search for the BOL of this particular shipment.

The shipper and the driver have similar BOL management apps, but the shipper has much more flexibility in editing the information in the BOL. On the other hand, the driver may not make changes to the BOL, except for the carrier exceptions as described above. This increases security of the BOL information because it provides control for changing the BOL data.

When the shipper and the driver interact to discuss the details of the load, they could use either the BOL shipper app or the BOL driver app. For example, a load is for taking 20 pallets of bricks from Detroit to Washington D.C. They can both then make sure that the load is what it is supposed to be. This avoids breakdown in communications between the shipper and the driver, which may cause confusion and conflicting understanding of the content of the shipment.

The BOL shipper app not only facilitates communications and interactions with the driver, but also assists in reconciling the shipment data. For example, if the shipment is for 20 pallets instead of 22, as stated in the BOL, the shipper can quickly change the number in the BOL from 22 to 20. When using a paper BOL, the shipper will cross out the wrong number and write in the correct number, but that change is only recorded on paper. Thus, people in the back office have to spend time reconciling the data in the system with the actual data of the shipment as noted.

However, when a change is made in the BOL app, the information is automatically updated in the BOL system, and may also be transferred to other backend systems of the shipper, such as accounting or the ERP/TMS 220. This represents a significant savings in the amount of time spent reconciling. In some example embodiments, the data resulting from updating the BOL may be instantaneously transferred to the shipper systems, or the data may be batched and updated periodically, such as during the night.

Once the BOL is found by the shipper, the truck is loaded (operation 414) based on the information in the shipper's system or on the BOL driver app or BOL shipper app. Optionally, the BOL may be edited (operations 416, 418) by the shipper via the BOL shipper app.

Once the truck is loaded and the information in the BOL is up to date, the shipper may digitally sign off the shipment either through the BOL driver app, the BOL shipper app, or the BOL management web app. The BOL shipper app will ask the driver for the driver's signature and also for the driver phone number. The driver has the option of signing on the shipper's device or in the BOL driver app. In some example embodiments, a text message is sent to the driver confirming the signature for accepting the load.

The digital signatures, changes, and any issues noted by the driver are all timestamped. GPS locations with timestamps are taken at driver arrival and exit from the pickup location, which will be used to cross-reference the times of digital signing and any other changes made to the BOL in an effort to reduce forgery and fraud, such as, for example, to detect that a driver claimed that she was waiting for 5 hours when the BOL management tracking shows that the driver took only two hours to load the truck and depart.

If the driver does not have the BOL driver app downloaded, the driver is asked to download the BOL driver app so that the driver may have access to the BOL information while on the road. If the driver is unable to download the BOL driver app, then a paper copy printed from the BOL management web app, or the BOL shipper app, can be furnished.

The BOL management service includes measures to track, monitor, and eliminate forgeries and fraud within the shipping industry. The tools to decrease fraud and forgery include time stamping all changes to the BOL and making them immutable within the BOL store. For example, if a driver signs a pickup for 22 pallets but arrives to the destination with 20 pallets, the BOL may not be forged or changed by the driver because the BOL is kept securely within the BOL management service.

Further, tracking the GPS locations of the driver as the load moves from source to destination, assists in detecting possible fraud regarding location of the load, wait times, travel times, etc. Additionally, geofencing detection assists in determining when the driver enters and leaves pickup and drop-off locations. For example, forgery on the date and time of pickup may be detected because the time when the driver signed for the load is kept with the BOL management service and GPS tracking also records the times and locations of the driver.

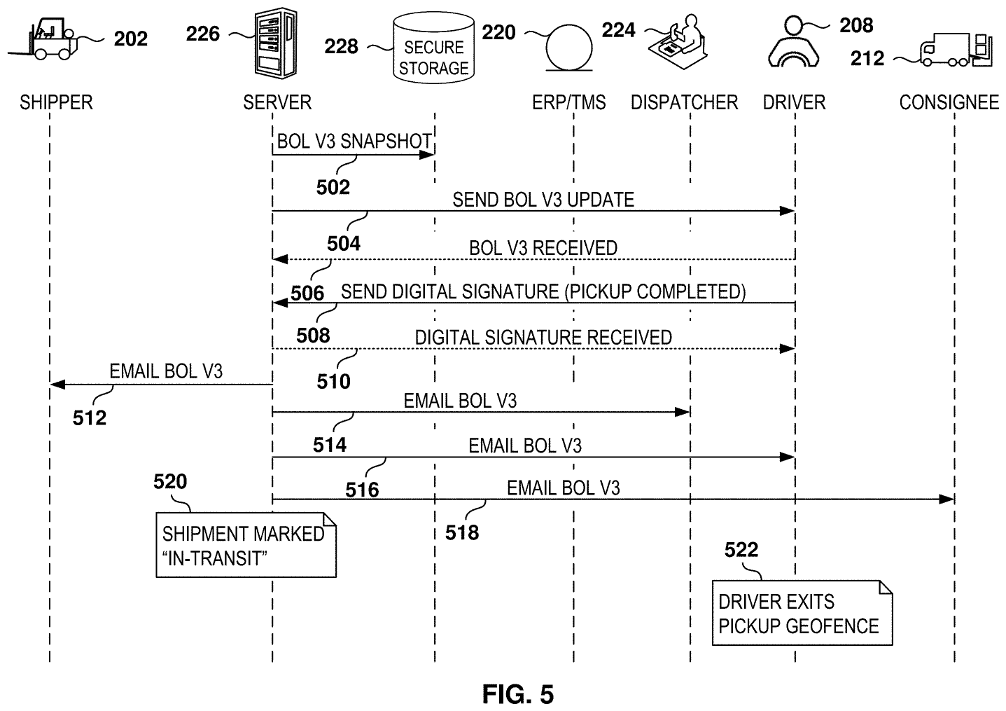

FIG. 5 shows the operations following the operations described with reference to FIG. 4. After the BOL is edited, the management server 226 stores (operation 502) the new version of the BOL (e.g., V3 in the illustrated example) in secure storage 228.

Further, the management server 226 sends (operation 504) the updated BOL to the driver 208, and the BOL driver app sends back (operation 506) a confirmation of receipt to the management server 226.

At operation 508, the BOL driver app sends the driver's digital signature signifying that the pickup is complete. The management server 226 sends back (operation 510) a confirmation that the digital signature was received.

Afterwards, the management server 226 sends updated versions of the latest BOL (e.g., V3 in the illustrated example) to the shipper 202 (message 512), the dispatcher 224 (message 514), the BOL driver app (message 516), and the BOL consignee app (message 518).

The status of the shipment in the BOL management platform is then automatically updated (operation 520) to “In Transit.” The driver then exits the geofence (522) in route to deliver the product. The BOL management platform leverages the GPS technology on the BOL driver app in order to track the driver. The version of the BOL on the mobile device, and/or the emailed version, will be used as evidence of the shipment content for authorities if necessary. Further, BOL management support is available for drivers who may have issues with the app while in transit.

The BOL data shows in and out times. One prevalent problem in the shipping industry is detention, which is the amount of time that a driver has to wait, after arriving to the pickup location, for the load to be loaded. Typically, the driver gets paid for the time spent in detention, so it sometimes happens that the driver claims to be in detention longer than the actual wage time. For example, the driver my say that she was in detention for six hours while the driver in fact waited for only four hours. The shipper may argue that the driver was only waiting for three hours instead of four. Therefore, there could be inaccurate information on both sides.

Since the BOL management service keeps accurate track of the timing of events related to the shipment, such as arrival time and departure time, it is possible to accurately calculate the detention time. This way, disputes about detention times may be easily resolved by showing that the BOL management service stores the in and out times.

Additionally, the BOL management service provides statistics on detention times for the shipments of a given shipper. This way, the shipper may analyze the data to determine reasons for the detention, such as too many shipments scheduled at the same time or for planning. Also, it is possible to determine when the driver arrives ahead of the scheduled pickup time, which may increase detention time. When drivers and shippers see that the in and out times are kept accurately, then they will not be inclined to “fudge” the in and out times.

As the driver moves, the status is updated on the BOL management service. A big problem in the shipping industry is that, many times, some of the parties know about the shipment times, but not all the parties are aware. For example, the consignee 212 that is supposed to receive the shipment is not aware of the pickup time or when the shipment is going to arrive.

With the BOL management service, all the parties can check the shipment status on the open BOLs and find out when the shipment was picked up, the current position of the truck, estimated time of arrival, etc.

In transit, the driver has access to the BOL on the BOL driver app, and if the driver is pulled over, e.g., by police, the driver can present the BOL on the mobile device 232 to the authorities and show what is in the back of the truck.

At event 522, the driver exits the pickup geofence, which is detected based on the GPS position of the mobile phone and the geofence distance configured for the geofence.

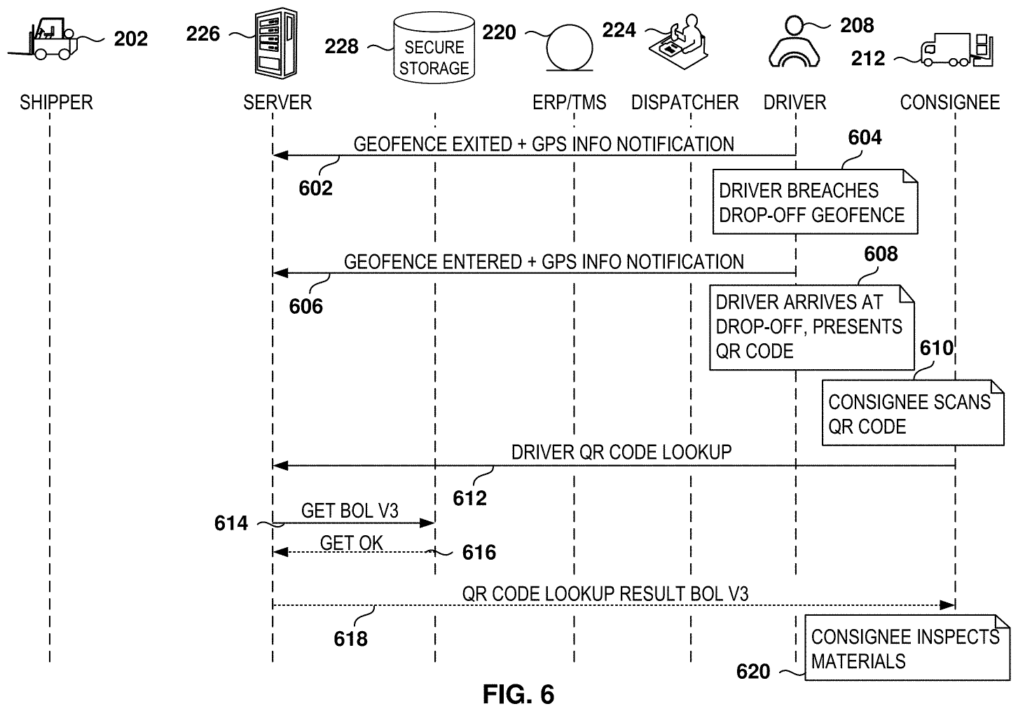

FIG. 6 shows the operations following the operations described with reference to FIG. 5. After the driver exits the pickup geofence at event 522, the BOL driver app sends (operation 602) a notification to the management server 226 indicating that the geofence has been exited and an update with the current GPS location.

During the trip, the position of the truck is monitored via GPS locations captured by the driver's mobile device 232 and sent to the management server 226. The different entities monitoring the load are able to see the location updates provided by the BOL driver app.

At event 604, the driver breaches that drop off geofence (e.g., the consignee geofence 216). The size of the drop off geofence may be predefined or configured within the BOL management service. For example, the consignee 212 may configure the size of the geofence (e.g., 1 mile, 10 miles, 60 miles from the drop off location) in order to get notifications sooner or later regarding the upcoming arrival of the cargo.

Once the BOL driver app detects reaching the drop-off geofence, a notification is sent (operation 606) to the management server 226 with that status update and the current GPS location. In some example embodiments, notifications may also be sent to the different entities.

At event 608, the driver arrives at the drop-off area. If the consignee 212 is part of the BOL management service and is identified on the shipment as a party, then the consignee 212 will be able to review the BOL via the BOL web app or the BOL consignee app. In some example embodiments, the BOL consignee app is the same as the BOL shipper app, although the consignee may have restrictions to view or change certain fields (e.g., create new BOL). In other example embodiments, the BOL consignee app may have different options and interfaces than the shipper app.

The driver presents the unique identifier (e.g., the QR code) to the consignee 212 provided by the BOL driver app. The consignee 212 can scan the QR code and bring up the bill information on the BOL consignee app or use the BOL driver app to check the BOL information (e.g., content of the shipment).

The driver may present their mobile app with QR or bar code, delivery number, or driver phone number to the consignee to allow the consignee to pull up the correct information on their system (or BOL management service).

In some example embodiments, the consignee 212 scans (operation 610) the QR code, and a message 612 is sent to the management server 226 requesting the BOL for the BOL consignee app. The management server 226 gets (operations 614, 616) the latest version of the BOL (unless the BOL is already cached in the management server 226), and sends (operation 618) the results of the QR code lookup, that is the BOL, to the BOL consignee app. At operation 620, the consignee 212 inspects the materials received.

Provided the consignee is not using the BOL consignee app, the consignee may sign the BOL via the BOL driver app where consignee signature is requested. If the BOL is only available via the driver's ELD system, the consignee may be texted a version of the BOL to be digitally signed via an outside service (such as DocuSign®).

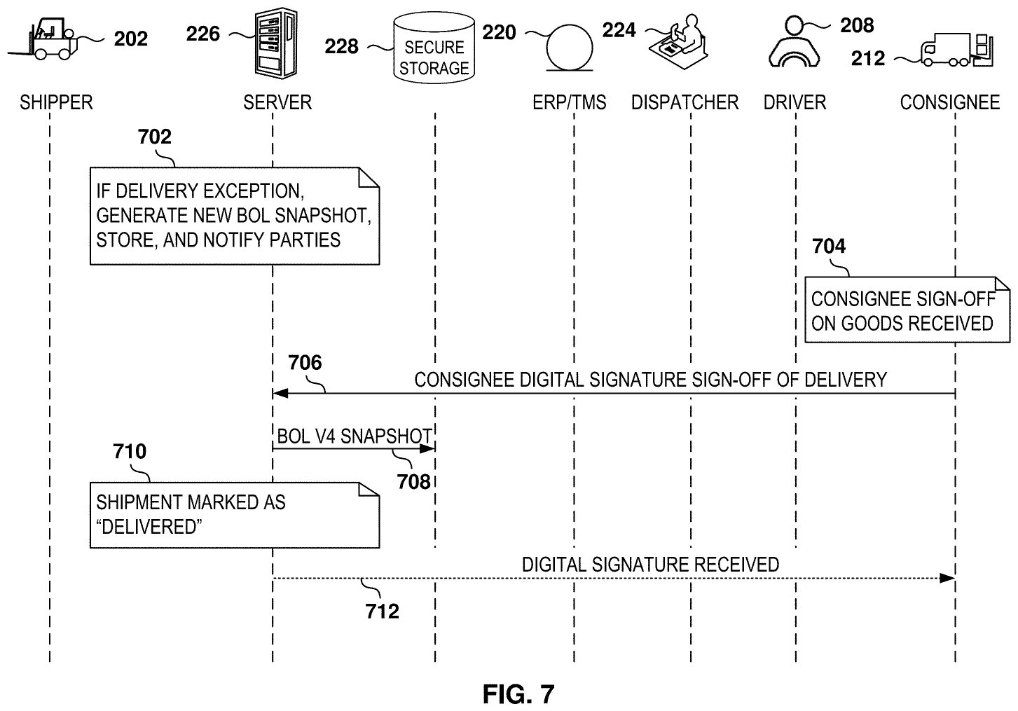

FIG. 7 shows the operations following the operations described with reference to FIG. 6. At this point, the consignee 212 may enter delivery exceptions 702 in the BOL using the BOL consignee app. For example, there is some damage to the goods, the amount of goods received does not match the amount of goods in the BOL, etc.

If the consignee 212 refuses to accept the shipment, then the delivery exceptions are noted and the dispute should be handled between the shipper, carrier, and receiver off-line.

If the consignee 212 accepts the goods, the consignee 212 signs off 704 on the goods received utilizing the BOL consignee app or the BOL driver app. The consignee signoff signature is sent (operation 706) to the management server 226 from the BOL consignee app (as illustrated in FIG. 7) or from the BOL driver app (not shown).

After receiving the consignee signoff signature, the management server 226 updates the BOL with the consignee signature and creates a new version of the BOL (e.g., version V4 in the illustrated example). The new version of the BOL is then stored 708 in secure storage 228.

Further, upon digital sign-off of the BOL by the consignee 212, the status of the shipment is automatically updated (operation 710) to delivered. Additionally, a digital-signature receive confirmation is sent (operation 712) from the management server 226 to the consignee 212 (e.g., BOL consignee app or BOL web app).

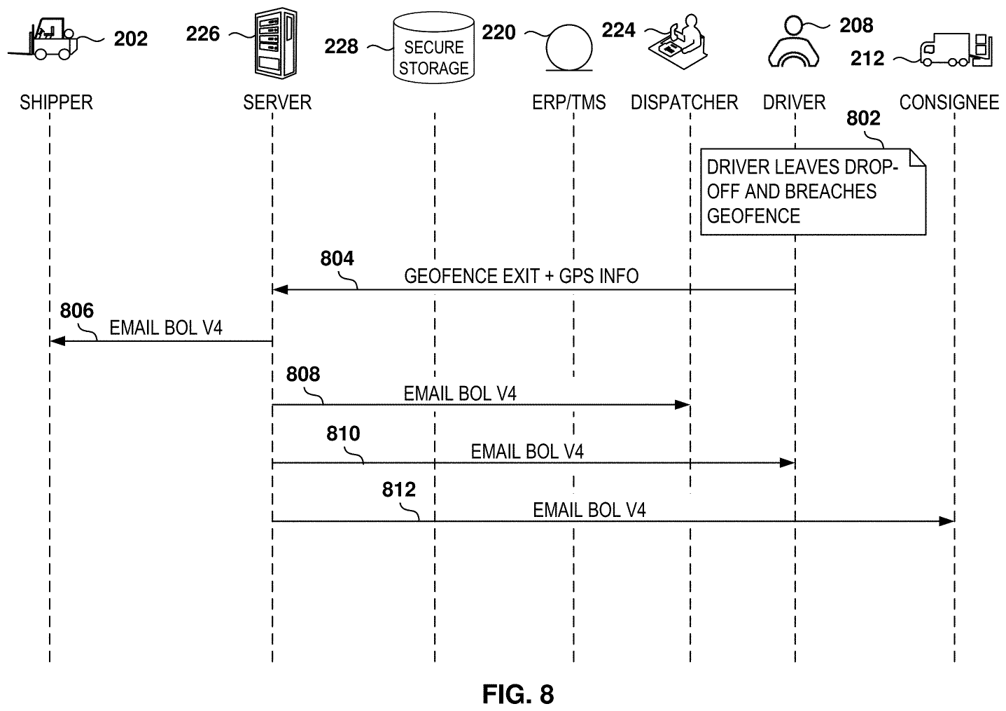

FIG. 8 shows the operations following the operations described with reference to FIG. 7. Afterwards, the driver 208 leaves the drop-off area and breaches 802 the consignee geofence 216 on the way out. The BOL driver app sends (operation 804) a notification to the management server 226 that the truck has left the geofence and the current GPS location.

At this point, the tracking of the driver, by the BOL driver app, ends after the driver exits the consignee geofence 216.

Once the driver leaves the geofence 216 of the delivery location, the current version of the BOL (e.g., version V4) is made available via email to the shipper 202 (message 806), dispatcher 224 (message 808), driver 208 (message 810), and consignee 212 (message 812).

The in and out times at both the pickup and delivery locations are automatically noted on the BOL. In some example embodiments, the in and out times are recorded as the driver breaches the geofence. In other example embodiments, the in and out times are recorded when the driver enters or leaves the pickup location (within a few meters) and the drop-off location (within a few meters).

It is noted that the embodiments illustrated in FIGS. 3-8 are examples and do not describe every possible embodiment. Other embodiments may utilize a different order of events, combine two or more messages into one, add additional messages (e.g., position tracking messages), omit some of the messages, utilize different BOL apps for capturing BOL data, etc. The embodiments illustrated in FIGS. 3-8 should therefore not be interpreted to be exclusive or limiting, but rather illustrative.

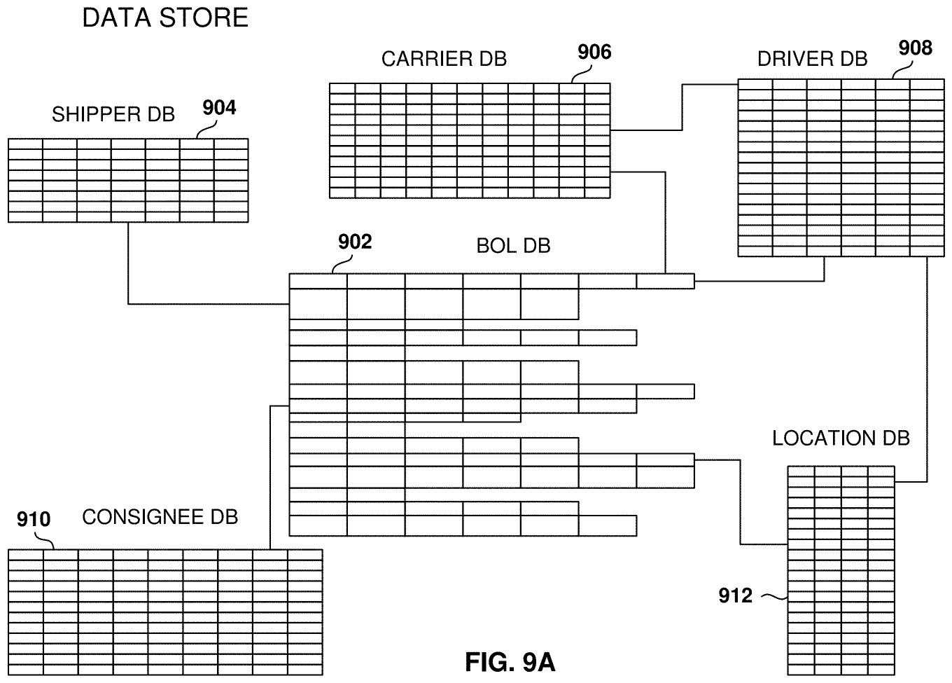

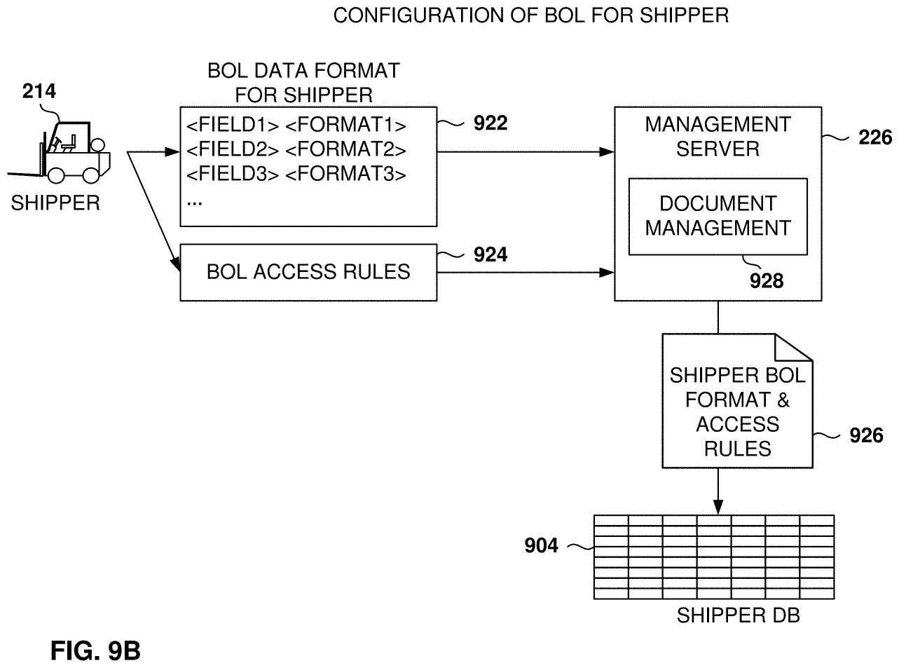

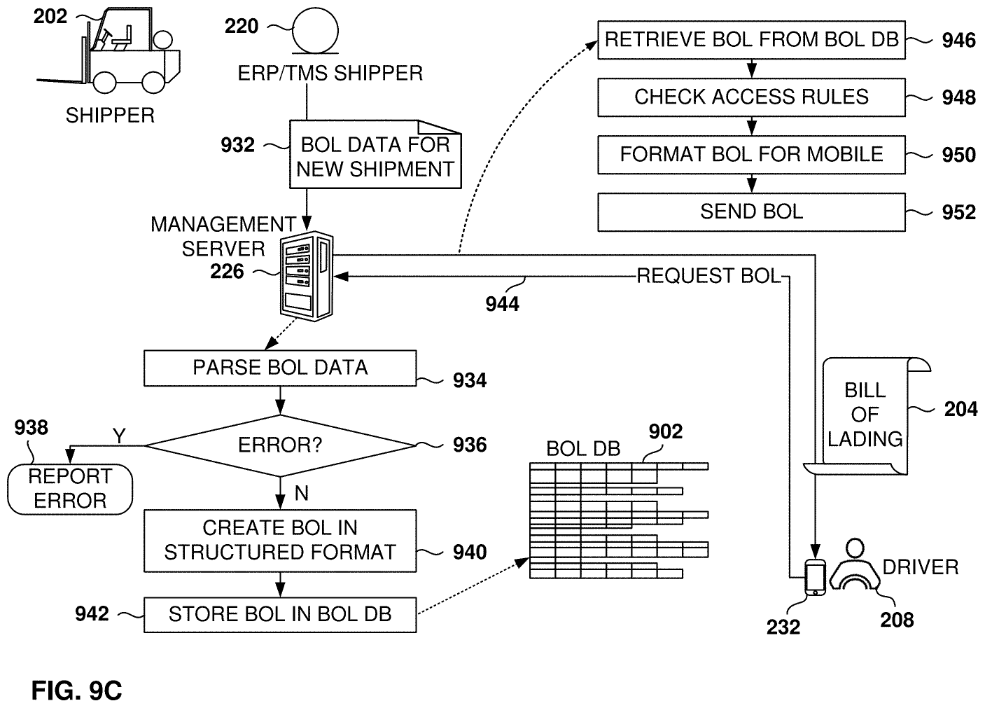

FIG. 9A illustrates the structure of the data store, according to some example embodiments. The BOL management service includes one or more data storage devices (e.g., databases) for keeping BOL data at the BOL server or the secure storage in the cloud. In one embodiment, the databases (DB) include shipper DB 904, carrier DB 906, driver DB 908, consignee DB 910, location DB 912, and BOL DB 902. The data stored may be stored in one database or in multiple tables or databases, may be stored in hard drives or in other types of memories, and the databases may include indexes or pointers linking the data from the different databases.

A particular BOL may include an index into the shipper DB 904 for the shipper data, an index to the carrier DB 906 for carrier information, an index to the driver DB 908 for driver information, an index to the consignee DB 910 for consignee information, and an index to the location DB 912 for tracking information. Although some links among the databases are illustrated in FIG. 9A, other embodiments may include additional links among the DBs.

The shipper DB 904 includes shipper data, such as shipper name, shipper identifier (ID) number, BOL data format definition, BOL access rules, shipper login, shipper password (encrypted), pickup or pickup locations with addresses, contact person, contact person phone number, contact person email address, contact person fax number, billing contact person, billing contact person phone number, billing contact person email address, and billing contact person fax number.

The carrier DB 906 includes carrier data, such as carrier name, carrier ID number, carrier login, carrier password (encrypted), carrier address, contact person, contact person phone number, contact person email address, contact person fax number, billing contact person, billing contact person phone number, billing contact person email address, and billing contact person fax number.

The driver DB 908 includes driver data, such as driver name, driver phone number, a Boolean flag indicating if the driver has installed the BOL driver app, driver phone number, driver's truck information, driver login, driver password (encrypted), driver's email, and carrier ID number of the driver's employer.

The consignee DB 910 includes consignee data, such as consignee name, consignee ID number, consignee login, consignee password (encrypted), pickup/drop-off location or locations with addresses, contact person, contact person phone number, contact person email address, contact person fax number, billing contact person, billing contact person phone number, billing contact person email address, and billing contact person fax number.

In some example embodiments, the BOL structure for each shipper is customizable, that is, each shipper customizes the BOL data according to their preference. Although a default BOL data structure may be used by one or more shippers, the BOL management service allows each shipper to configure and the presentation of the BOL data in the different interfaces.

In some example embodiments, the BOL DB 902 is for storing BOLs for multiple shippers. The data for each shipper is stored in the BOL DB 902 in the format customized for each shipper, so the different entries in the BOL DB 902 may have different formats (for illustration purposes, each entry in the BOL DB 902 is represented as one row). Further, for each BOL, multiple entries are stored in the BOL DB 902 as changes are made to the BOL (for illustration purposes, the multiple entries in one row refer to the number of versions of a particular BOL stored). In some example embodiments, the BOL DB 902 is a document management database, where each entry has its own format.

Each entry in the BOL DB 902 includes a list of pairs, each pair including a field name and a field value. For example, a field may be defined for the carrier ID as (<carrierID>, <carrier index>) (e.g., <carrierID>, <143>, where 143 is an index into the carrier DB 906).

This BOL store structure provides great flexibility for the BOL management service in order to accommodate the particulars for the systems implemented by the shipper. This way, the shipper does not have to change their data infrastructure in order to operate with the BOL management service.

Some examples of BOL data fields include BOL ID, carrier ID, driver ID, consignee ID, information about truck carrying the load, customer order information, carrier information, pickup instructions, pickup date, pickup location, drop-off instructions, drop-off date, drop-off location, driver pay, shipper signature and date, driver signature and date, consignee signature and date, flag indicating if the trailer was noted by the shipper, flag indicating if the trailer was noted by the driver, flag indicating if the freight was counted by the shipper, flag indicating if the freight was counted by the driver, carrier exceptions, delivery exceptions, piece count (pcs), and tracking location data received from the BOL driver app.

The customer order information of the BOL includes one or more customer orders, each customer order including customer order number, number of packages, weight, pallet, slip, and additional shipper info.

The carrier information of the BOL includes handling information (quantity and type), package information (quantity and type), weight, and commodity description.

Thus, one BOL includes the corresponding information from the DB tables described above. However, the BOL location tracking data may not be included in the BOL presented to authorities but may be accessed by the different parties that are allowed to access the tracking data.

In some example embodiments, the shipper identifies rules for accessing the BOL data in order to define which parties may view or edit each field. For example, the shipper may change the shipping information, but the driver and the consignee may not change the shipping information, although they can enter carrier exceptions or delivery exceptions. Additionally, some internal data may be used by the BOL management service that is controlled by the BOL administrator.

The BOL management system allows for redundant storage via cloud services for immediate and ongoing access to BOL documents. In some example embodiments, each change to the BOL is timestamped and stored digitally and redundantly in cloud services and on the management server 226. Further, the BOL data may be stored on blockchain-based systems where each PDF version of the BOL is created with an imprinted unique hash-value based on a proprietary algorithm to guarantee uniqueness of the data within the BOL.

FIG. 9B illustrates the customization of the BOL for a particular shipper, according to some example embodiments. The BOL parameters may be customized for each shipper such that each shipper has its own definition of BOL parameters, the formatting of the BOL for presentation on the BOL interfaces, etc.

During initialization of the BOL management service, the shipper 202 provides the BOL data format 922 (also referred to as document structure definition) and the BOL access rules 924. Typically, the BOL data format 922 is a structured-document format provided by the application managing the shipments for the shipper 202, such as the ERP application or the TMS application. The structured-document format defines the structure of a document that includes field names and values corresponding to the field names.

In some example embodiments, the BOL data format 922 includes a list of pair values for field name (e.g., address, date, item, description, quantity) and field format (e.g., string, integer, real number, array, etc.). In some example embodiments, the BOL data format 922 is in JavaScript Object Notation (JSON), which is an open-standard file format that uses human-readable text to transmit data objects consisting of attribute—value pairs and array data types (or any other serializable value). Other possible formats include Extensible Markup Language (XML) and AJAX (asynchronous JavaScript), but other format definitions may be used.

The BOL access rules 924 define which users may access the BOL data and what permissions these users have. Further, the BOL access rules 924 may be defined for each field in the BOL, such that different fields have different access rules. That BOL access rules 924 identify the users with access, such as the dispatcher 224, one or more drivers 208, the consignee 212, etc.

For each field, the BOL access rules 924 define who can view the field, at what time the information may be viewed (e.g., consignee can see BOL data after the driver picks up the load), and who can edit the field to change its value. Some of the fields will be read-only for certain users, while some fields may be edited by other users (e.g., carrier exceptions).

The document management module 928, in the management server 226, receives the BOL data format 922 and the BOL access rules 924 from the shipper 202. The document management module 928 processes the BOL data format 922 and the BOL access rules 924 accordingly and then stores, in operation 926, the BOL data format 922 and the BOL access rules 924 for future use according to the BOL system defined structures. In one example embodiment, the information is stored in the shipper database. In other example embodiments, the information is stored in the BOL databases, such that each BOL includes information regarding its structure as well as the values for the fields defined within the BOL. Other embodiments may store the data in a separate database.

FIG. 9C illustrates the processing of BOL data for the shipper, according to some example embodiments. A new shipment is created by the shipper 202, such as by utilizing the ERP/TMS 220 shipper applications. The management server 226 interacts with the ERP/TMS 220 to access the BOL data 932 for the new shipment.

The document management module 928 in the management server 226 parses (operation 934) the BOL data 932 and applies the BOL data 932 to the data structure for the BOL defined previously by the shipper 202.

At operation 936, a check is made to determine if the parsing was successful or an error was detected. If parsing the BOL data 932 results in an error, the method flows to operation 938, where the error is reported and the BOL data 932 is not accepted. The system administrator will have to analyze the BOL data 932 to determine the cause of the error, and the shipper 202 may be notified that the BOL data 932 did not match the defined spec or there was some error during transmission.

If the check at operation 936 determines that the parsing was successful, the method flows to operation 940 where the BOL is created in the structured format defined for the shipper 202. At operation 942, the new BOL is stored in the BOL DB 902.

In some example embodiments, the policies for accessing the BOL data 932 are also stored in the BOL DB 902. The BOL policies may be the policies defined originally by the shipper 202, but the shipper 202 also has the option of selecting particular access rules for the new BOL.

The driver 208 has been given access to the BOL 204, e.g., to pick up a load that the driver 208 is going to carry. Using the mobile device 232, the driver 208 requests (operation 944) the BOL 204 using the BOL driver app.

The BOL management service supports the multiple types of BOL formats that different shippers may use. However, one driver may access BOLs from multiple shippers so that the BOL driver app has to be able to present any of the BOLs from the multiple shippers. The BOL management service provides the flexibility to format the BOL in order to present the BOL in the BOL driver app, for all types of shippers.

After receiving the request for the BOL 204, the management server 226 retrieves (operation 946) the BOL 204 from the BOL DB 902. At operation 948, the BOL management service checks the access rules to determine if driver 208 has permissions to access the requested BOL 204. If the driver does not have access, the BOL 204 will not be sent to the driver.

When the driver has access to the BOL 204, at operation 950, the BOL 204 is formatted for the graphical user interface in the mobile device 232 of the driver 208. Since each shipper may include different fields, or the same fields in different orders, the formatting for the graphical user interface takes into account the BOL format set forth by this shipper. In some example embodiments, presenting the BOL information includes presenting the list of field names in field values corresponding to this BOL 204.

At operation 952, the formatted BOL 204 is sent to the BOL driver app in the mobile device 232 for presentation to the driver 208. Upon receipt by the BOL driver app, the BOL driver app iterates through the list of fields to display the key-value pairs.

In some example embodiments, the shipper 202 may access the management server 226 and define how the different fields are presented in the BOL driver app. Then, when the BOL 204 is sent to the driver 208, the BOL 204 is formatted according to the formatting rules defined by the shipper 202.

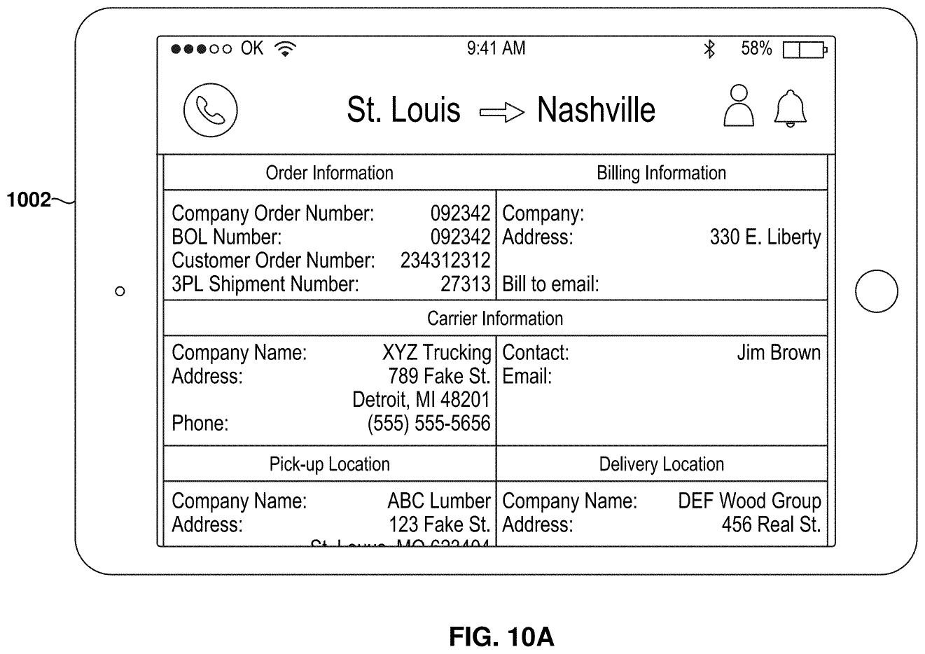

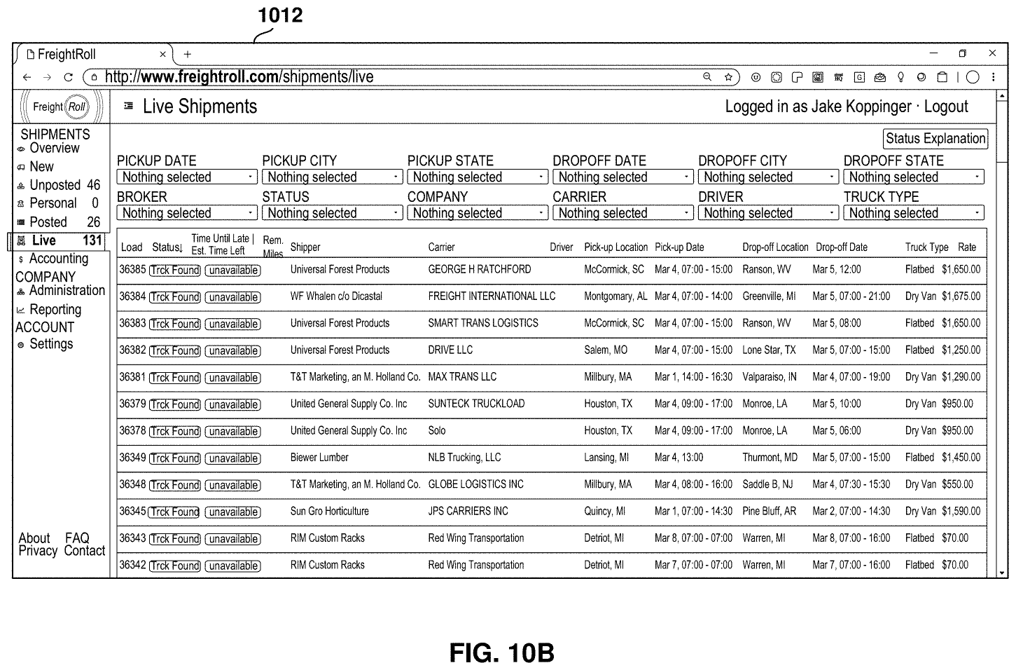

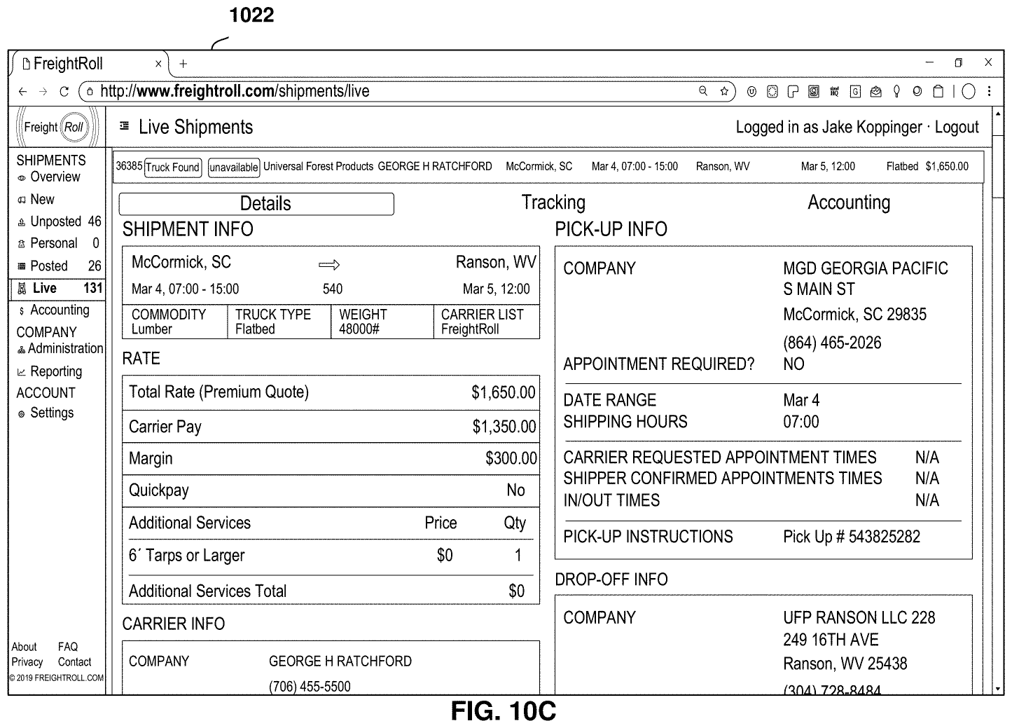

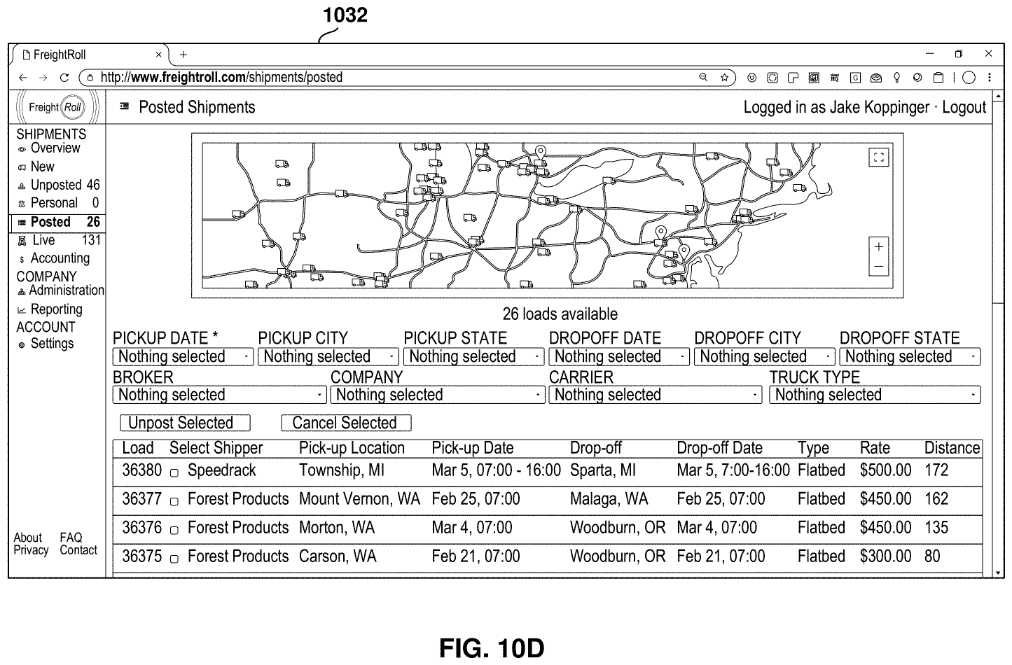

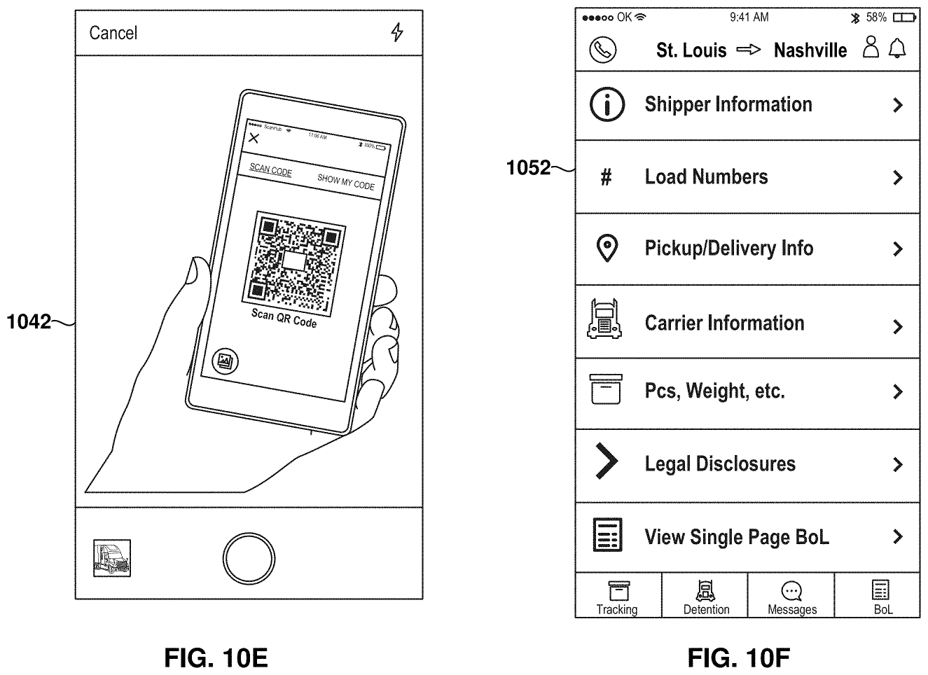

FIGS. 10A-20B show user interfaces provided by the electronic document management system, according to some example embodiments. It is noted that FIGS. 10A-20B illustrate several of the BOL interfaces. Although some interfaces may be presented as seen for an entity, the same or similar interfaces are also available for other entities. For example, a shipper may see results of open BOLs as well as the driver, but the shipper and the driver will see the respective data. Further, the shipper may be able to modify some of the data fields on the BOL, while the driver may not, but the interfaces will be similar in many cases. Thus, the embodiments illustrated in FIGS. 10A-20B are examples and do not describe every possible embodiment. Other embodiments may utilize different layouts or data representation. The embodiments illustrated in FIGS. 10A-20B should therefore not be interpreted to be exclusive or limiting, but rather illustrative.

FIG. 10A is a user interface 1002 for showing the BOL information on a tablet device, a laptop, a personal computer, or a phone with a large screen, according to some example embodiments. The user interface 1002 shows the top of the BOL; additional data of the BOL may be read by scrolling down the user interface 1002.

As described above, the formatting of the BOL on a user interface is based on the BOL structure data defined by the shipper. The BOL formatting may instruct the BOL user interface how to present the data, such as to present the order information next to billing information, present carrier information in two columns, present pickup location next to delivery location, etc.

FIG. 10B is a user interface 1012 for searching live shipments in the BOL web interface, according to some example embodiments. The user interface 1012 includes a plurality of selectable search fields for entering search parameters to search for live shipments.

In the illustrated example, the search fields include pickup date, pickup city, pickup state, drop-off date, drop off city, broker, status, company, carrier, driver, and truck type. In other example embodiments, fewer search fields may be included or additional fields may be added, such as any of the database fields identified above with reference to FIG. 10A.

The user may select one or more of the fields, and the condition selected would be joined with a logical ‘and’ to delimit the search for live BOLs. In some example embodiments, the search results are presented in tabular form, and the user may select any of the entries to get additional data for the selected entry.

The results table includes fields for load number, shipping status, estimated time left until delivery, remaining miles to the drop-off location, shipper name, carrier name, driver name, pickup location, pickup date, drop-off location, drop-off date, truck type, and rate or price paid for the shipment. In other example embodiments, fewer table columns may be presented or additional fields may be added, such as any of the data identified with the BOL described above.

FIG. 10C is a user interface 1022 for viewing the details of a live shipment. If the user selects one of the search results so in FIG. 10A, the user interface 1022 for the live shipment is presented, but the same page may also be made available from other options presented in the BOL app.

The live shipment information includes some of the data associated with the shipment described above, such as pickup and drop-off information, the rate for the load, the driver pay, carrier info, etc.

FIG. 10D is a user interface 1032 for showing the location of live shipments. The user interface 1032 is similar to the user interface 1012 of FIG. 10B but it also includes a map with the locations of the trucks carrying live shipments. In some example embodiments, the truck icons on the map are selectable, and when the user selects one of the trucks, the shipment information associated with the truck is presented on the BOL app. The user may also zoom in or out of the map to obtain a high resolution of the map or expand the area covered in the map.

FIG. 10E illustrates 1042 a driver showing a QR code on the BOL driver app to the shipper to identify the shipment being picked up. The shipper can then scan the QR code with the BOL shipper app and the BOL information is presented automatically after the management server 226 identifies the QR code and retrieves the BOL data.

In some example embodiments, the BOL shipper app is bundled with a tablet having a camera, and the shipper will receive the tablet with the BOL shipper app already customized for the shipper when the shipper purchases the BOL management service. In other example embodiments, the BOL shipper app may also be downloaded from the BOL server or an app repository.

FIG. 10F is a user interface 1052 for the BOL driver app, according to some example embodiments. The user interface 1052 includes four menu options, as shown at the bottom of the user interface 1052. The four options include menus for tracking, detention, messages, and BOL.

The illustrated example in FIG. 10F shows the options for the BOL menu, and the options include shipper information; load numbers; pickup and delivery information; carrier information; PCS, weight, and other BOL data; legal disclosures, and view single page BOL.

If the user selects shipper information, the information of the shipper is described. Similarly, if the load numbers option is selected, load number information for one or more BOLs are presented. The pickup and delivery information provides the details for the pickup and delivery location.

The carrier information option describes information about the carrier. The PCS, weight, and other BOL data shows information about possible PCS, weight, and other BOL information besides the information presented in the other options.

The legal disclosures option describes legal terms associated with the BOL. Further, the option to view single page BOL will show a summary version of the BOL in one page.

The legal-disclosures option will present the legal disclosure for this BOL, such as the legal disclosure presented in Table 1 below:

TABLE 1
Legal disclosures

This is to certify that the above-named materials are classified,
marked and labeled and are in proper condition for transportation
according to the applicable regulations of the DOT.
Carrier acknowledges receipt of packages and required
placards. Carrier certifies emergency response information was made
available and/or carrier has DOT emergency response guidebook or
equivalent documentation in the vehicle. Property described above is
received in good order, except as noted.
Received subject to individually determined rates or contracts
that have been agreed upon in writing between the carrier and shipper,
if applicable, otherwise to the rates, classifications and rules that have
been established by the carrier and are available to the shipper, on
request.

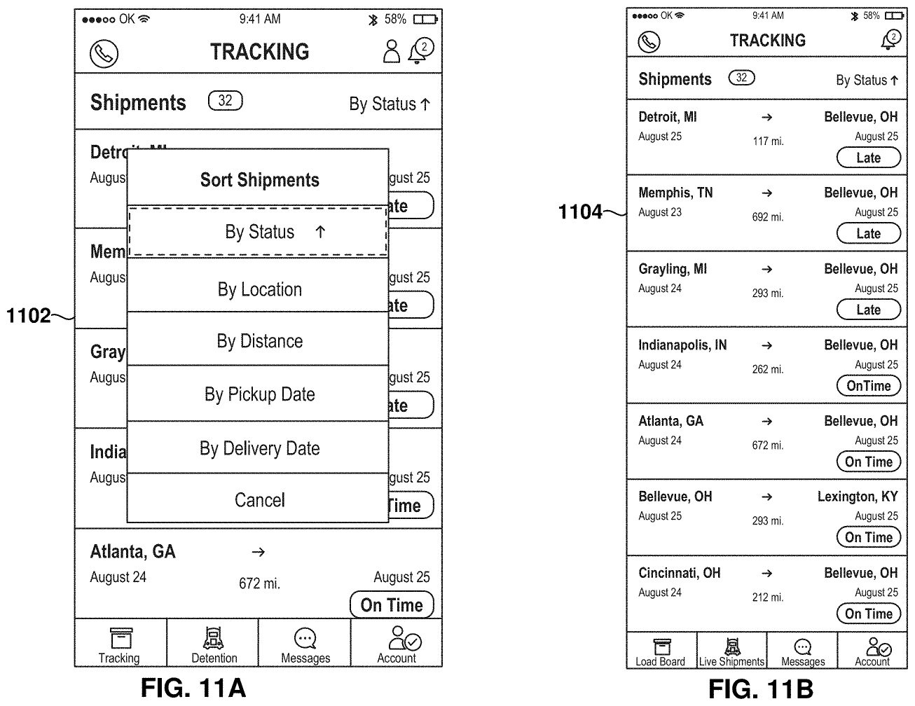

FIG. 11A is user interface 1102 for tracking shipments in the BOL shipper app, but similar options are available in other BOL apps. A search menu is provided for tracking shipments, and the shipments may be sorted by different criteria, such as by status (e.g., waiting for pickup, picked up, in transit, drop-off location, delivered), by location, by distance from pickup to drop-off, by pickup date, and by delivery date.

Once the user enters a search criterion (e.g., show all live shipments), the results would be sorted according to the criteria selected by the user. In some example embodiments, the default is by status, but other defaults may be used or configured by the user.

FIG. 11B is a user interface 1104 showing shipments. The shipments are shown in a list, including the source city, the destination city, the pickup date, the distance between source and destination, the delivery date, and a button showing status (e.g., late, on time, delivered). The user can scroll down the page to see additional shipments.

If the user selects one of the shipments (e.g., by clicking on the shipment or touching the shipment on a touchscreen), additional details are provided for that shipment, such as the BOL information.

Some shippers have to deal with a large number of shipments on a daily basis, with trucks coming in and out constantly. By presenting the shipments in a clear form, such as in the user interface 1104, the shipper can quickly identify the shipments that must be addressed at the time, as well as quickly identify the status of the shipment. If the shipper selects one of the shipments, the shipper can also access additional driver information, and tracking information if available. If the truck has GPS enabled, the BOL shipper app will provide the current, or recent, location of the truck. In some example embodiments, the BOL management service can ping the BOL driver app to get the current position of the driver.

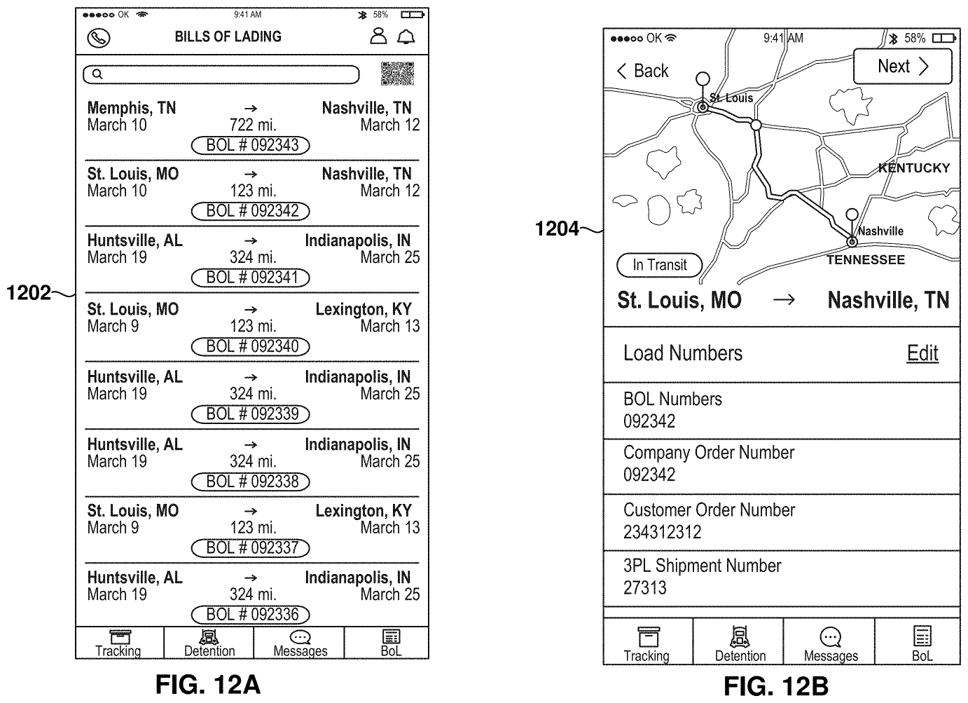

FIG. 12A is a user interface 1202 for showing BOLs in the BOL shipper app. The BOL driver app provides a search option for searching for specific BOLs, or searching for all BOLs.

Once the BOL(s) are identified, the BOL driver app lists the BOL, and different sort options may be selected for sorting, such as by BOL number, pickup date, delivery date, pickup city, drop-off city, etc. The illustrated user interface 1202 lists BOLs by BOL number. If additional BOLs are not present on the home screen, the user may scroll down to see the additional BOLs.

Each BOL entry includes pickup city, drop-off city, distance, pickup date, drop-off data, and a button with the BOL number. If the user selects the button with the BOL number, the complete BOL information is presented.

In some example embodiments, the BOL search searches the information available on the mobile device 232 of the driver. In other example embodiments, the BOL driver app will query the BOL server to obtain the up-to-date list of BOLs for the shipper.

FIG. 12B is a user interface 1204 for presenting information about a BOL. A map presents the source, destination, and the expected route. Further, a status button shows the status of the shipment. If the shipment is in transit and the location of the truck is known (or approximately known), an indicator is shown for the location of the truck, such as a round circle imposed on the route, but other indicators may be shown, such as an icon of a truck.

Further, additional information is presented below the map, such as BOL number, company order number, customer order number, shipment number, etc. As the user scrolls down the page, additional BOL information is provided.

In some example embodiments, the driver has the option to have the position of the mobile device tracked or not. Some drivers may have privacy concerns and do not want to be tracked. However, the trucking industry is becoming accustomed to additional monitoring of cargoes, such as with the use of ELDs, which are mandated by government regulations.

In some example embodiments, an interface may be provided between the BOL management service and the ELD device on the truck (e.g., ELD 210), such as by providing a Bluetooth interface or some other wired or wireless communication. The BOL driver app is then able to send ELD information to the BOL management service, and this information may be made available to the parties with proper authorization.

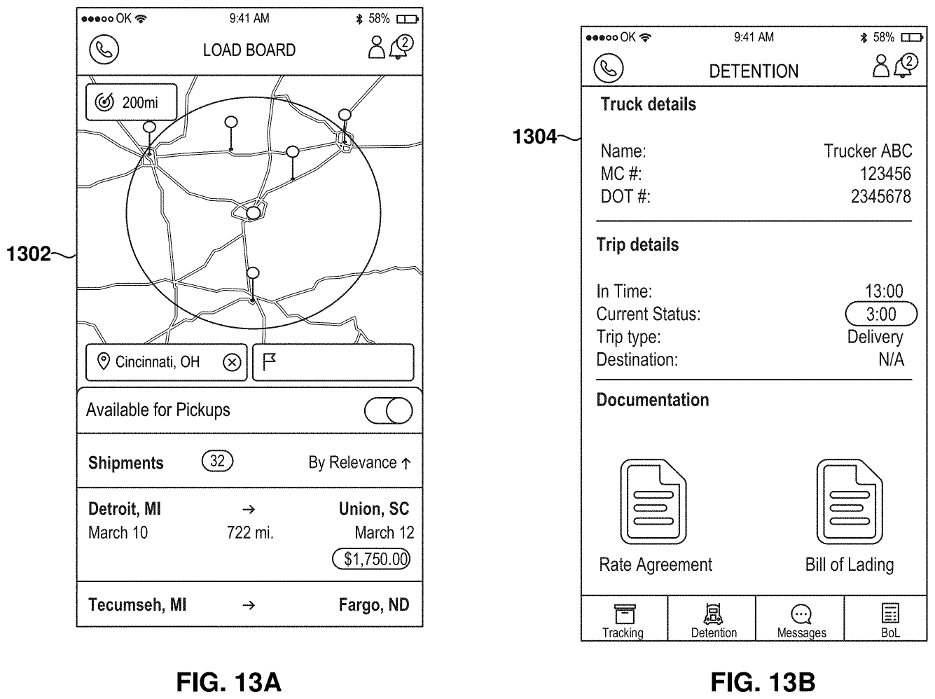

FIG. 13A is a user interface 1302 for the BOL driver app, according to some example embodiments. The user interface 1302 includes a map showing the current location of the driver and possible pickup destinations.

Further, the user interface 1302 includes a slideable button to indicate whether the driver is available for pickups or not. Further, shipment information is presented below the map with a list of past, current, and future shipments. If the driver selects one of the shipments, additional information is provided for that particular segment. Further, the driver has options for sorting the shipments by different categories (as illustrated in FIG. 11A). The illustrated example shows the shipments by relevance, which means that any upcoming shipments are presented first, with the first shipment presented at the top of the list.

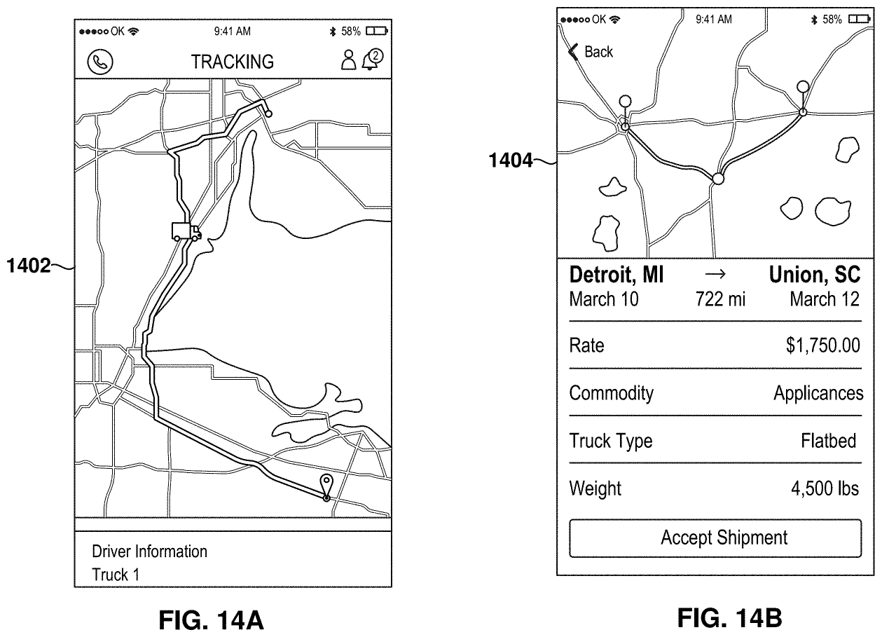

In some example embodiments, if the driver is currently with a live load, the map on the user interface 1302 shows an example route of the truck, such as the map described below with reference to FIG. 14A.

FIG. 13B is a user interface 1304 for the detention option of the BOL shipper app. The user interface 1304 presents information in case the driver is detained while waiting to load the truck. The detention information includes details about the truck (e.g., name, MC number, DOT number), information about the trip (e.g., in time, which is the time of arrival at the pickup location, current amount of the detention, trip type, destination). Further, the user interface 1304 provides options for viewing the rate agreement and the BOL.

The BOL shipper app keeps track of the amount of the detention time by tracking the arrival time and the departure time. The detention time is transmitted to the management server 226 and added to the information for the BOL stored on the databases.

In some example embodiments, the shipper may configure alarms that are triggered when detention times go beyond a predetermined threshold (e.g., two hours). When the alarms are triggered, the BOL shipper app and the BOL web app will generate the alarms, which may be presented on the user interface 1304 or received via a message, such as a text message, an email message, etc.

FIG. 14A is a user interface 1402 for tracking a shipment, according to some example embodiments. This type of interface may be presented to the different entities associated with the shipment. The user interface 1402 shows a map with the route from the pickup point to the drop-off point.

If the location of the truck is known, an icon is presented at the location where the truck is. In some example embodiments, traffic information is also presented on the map (e.g., with red portions showing where traffic congestion is present). Further, the user is able to zoom in on the route, such as by using two-finger touches on the touchscreen.

FIG. 14B is a user interface 1404 for accepting a shipment, according to some example embodiments. For example, the consignee may accept the shipment in the BOL consignee app after the truck is unloaded. Also, the consignee may accept the shipment on the BOL driver app, which will present an option to the consignee to enter a signature indicating that the shipment has been accepted.

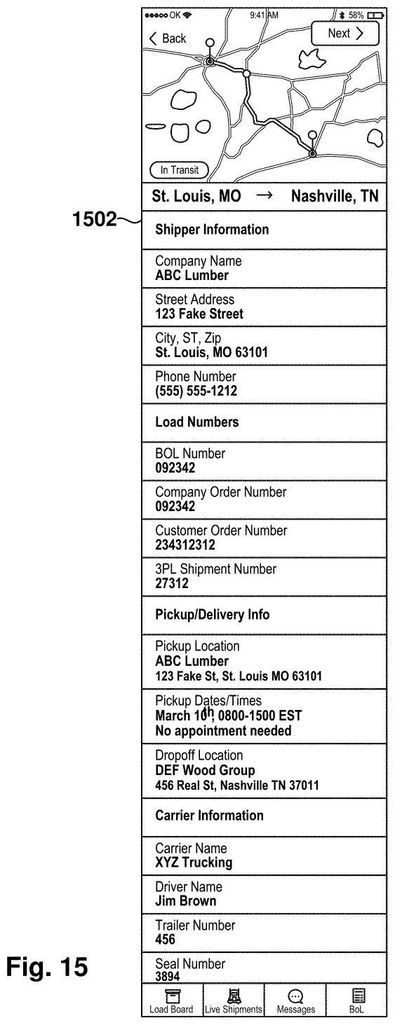

FIG. 15 is a representation of a complete BOL user interface, according to some example embodiments. Of course, a typical mobile phone will only present a section at a time of the user interface 1502, and the user may scroll up and down to access all the information.

The user interface 1502 includes a map of the route and text information about the BOL. The BOL information includes shipper information (e.g., company name, street address, city, state and ZIP code, phone number), load numbers (e.g., BOL number, company order number, customer order number, shipment number), pickup and delivery information (e.g., pickup location, pickup dates and times, drop-off location), and carrier information (e.g., carrier name, driver name, trailer number, and seal number).

Some of the fields may be edited, depending on the entity accessing the user interface 1502. As discussed above, the shipper may edit shipment information, but the driver may not change the shipment information. Further, the driver may enter carrier exceptions, but other entities are not able to alter this data.

For example, if the driver notes that the seal number is incorrect, the driver may ask the shipper to change the seal number. In some example embodiments, when the shipper changes and information on the BOL, the changes may be propagated back to the ERP/TMS systems (e.g., ERP/TMS 220, 222 in FIG. 2). The management server 226 interfaces with the ERP/TMS systems to make the updates.

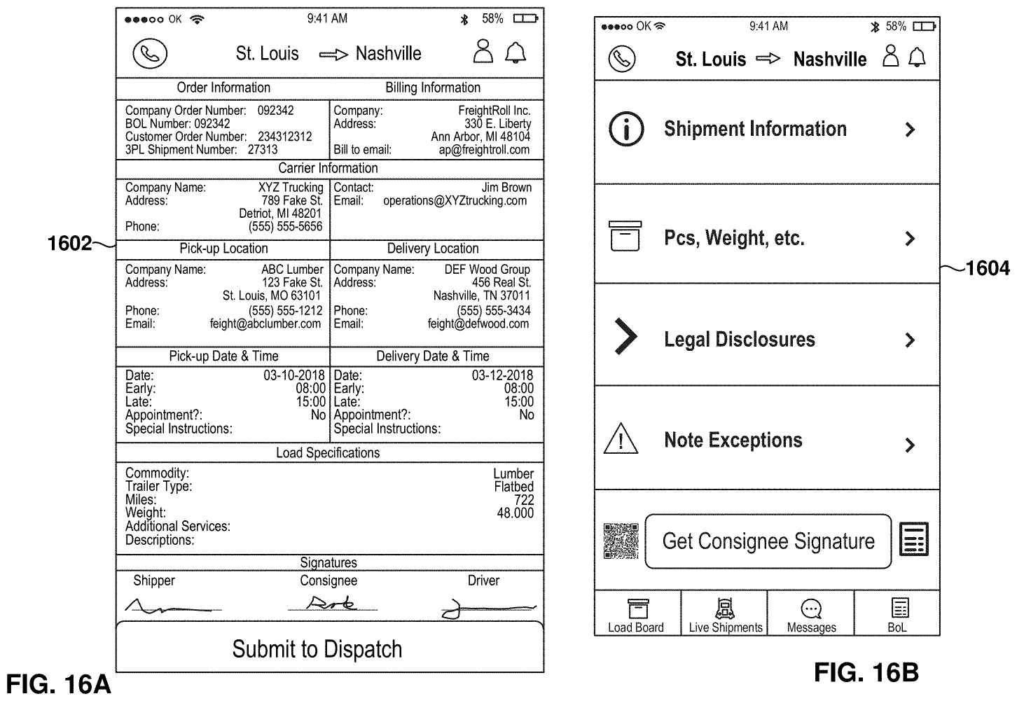

FIG. 16A is a user interface 1602 to present the BOL in a tablet or mobile device, according to some example embodiments. The user interface 1602 presents a summary of the key BOL data and includes the signatures at the bottom from the shipper, consignee, and driver.

The user interface 1602 is used by the BOL driver app and includes an option at the bottom for submitting the signatures, once they are all captured, by the driver to the dispatch.

At this point, an email goes out to each entity associated with the BOL (e.g., see messages 806, 808, 810, and 812 in FIG. 8) with the current version of the BOL that includes the signatures, where the email indicates that this is the complete bill of lading.

Depending on how the shipper and the carrier are set up, at this time payment may be triggered so the shipper pays the carrier right away, or a time deadline is set up for when the shipper has to pay, without the need of additional paperwork.

In some example embodiments, the information that the shipment is completed may be communicated to the ERP/TMS system, either in batch mode or in real time. Once the driver breaches the geofence on the way out, tracking stops.

FIG. 16B is a user interface 1604 for the BOL driver app, according to some example embodiments. The user interface 1604 includes many options at the bottom for load board, live shipments, messaging, and BOL. In the illustrated example, the driver has selected the BOL option.

The options for the BOL menu include shipment information; PCS, weight, etc.; legal disclosures; note exceptions (to enter carrier or delivery exceptions); and a button to get consignee signature.

If the driver selects the option to get the consignee signature, a new page will be shown with an entry field for the signature where the consignee can sign to approve delivery of the goods.

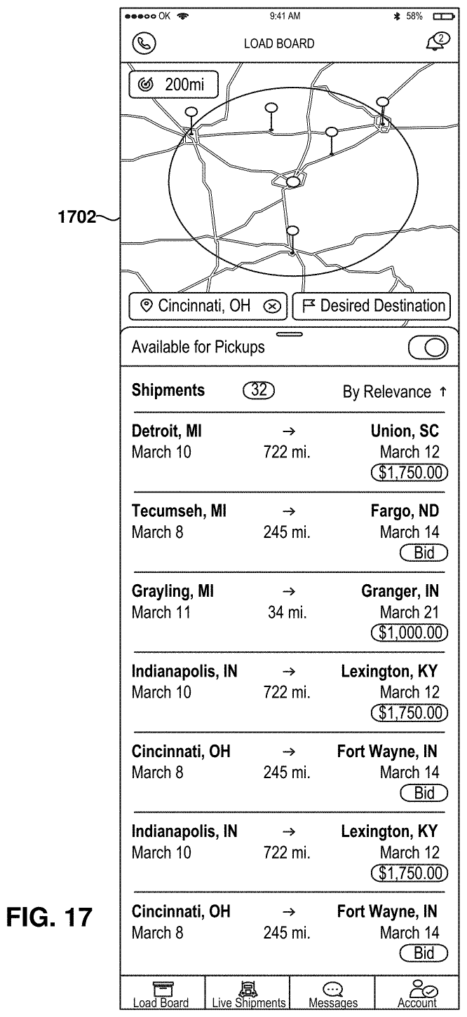

FIG. 17 is a user interface 1702 which includes a complete user interface for the load-board option, according to some example embodiments. Initially, the top part of the user interface 1702 will be presented on the driver's mobile device and the driver can scroll down the page to see additional entries.

The user interface 1702 includes a map at the top, which may be centered around the location of the driver, with possible pickup destinations. Additionally, a slideable button maybe selected by the user to flag if the user is available for pickups or not. If the driver is available for pickups, the BOL management service may act as an intermediary with shippers to find possible loads for the driver.

A list of shipments is provided below, where each shipment includes pickup location, destination location, pickup date, distance, drop-off date, and shipment-accorded amount or an option to place a bid for the load.

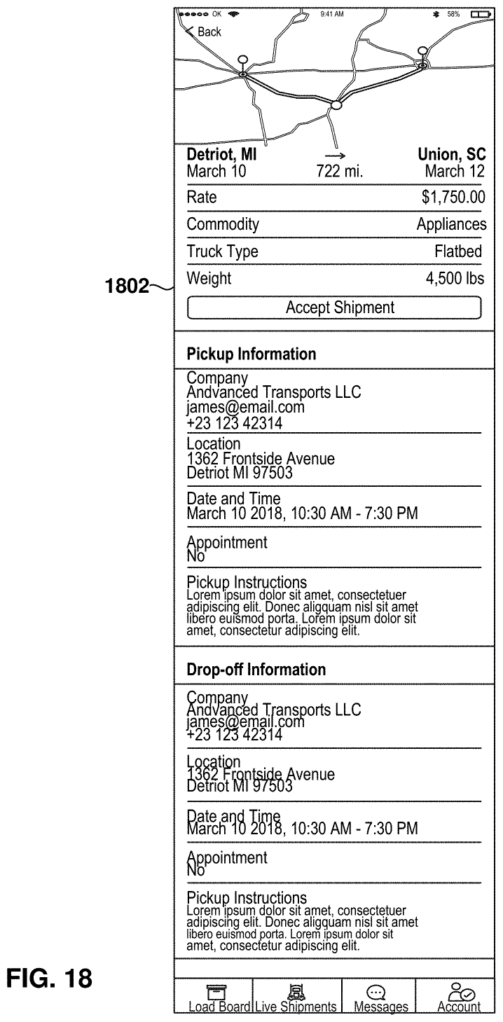

FIG. 18 is a user interface 1802 in the BOL driver app for accepting a shipment, according to some example embodiments. As before, part of this user interface 1802 may be shown on the screen of the mobile device and the user may scroll down to access all the information.

The user interface 1802 includes a map showing the route from pickup to drop-off, and a summary for the load, which includes the rate for the shipment (e.g., $1,750), the type of commodity (e.g., appliances), the truck type for the load (e.g., flatbed), and the weight of the load (e.g., 4500 pounds).

A button is provided for accepting the shipment, and below the button more detailed information about the load is provided, such as pickup information and drop-off information.

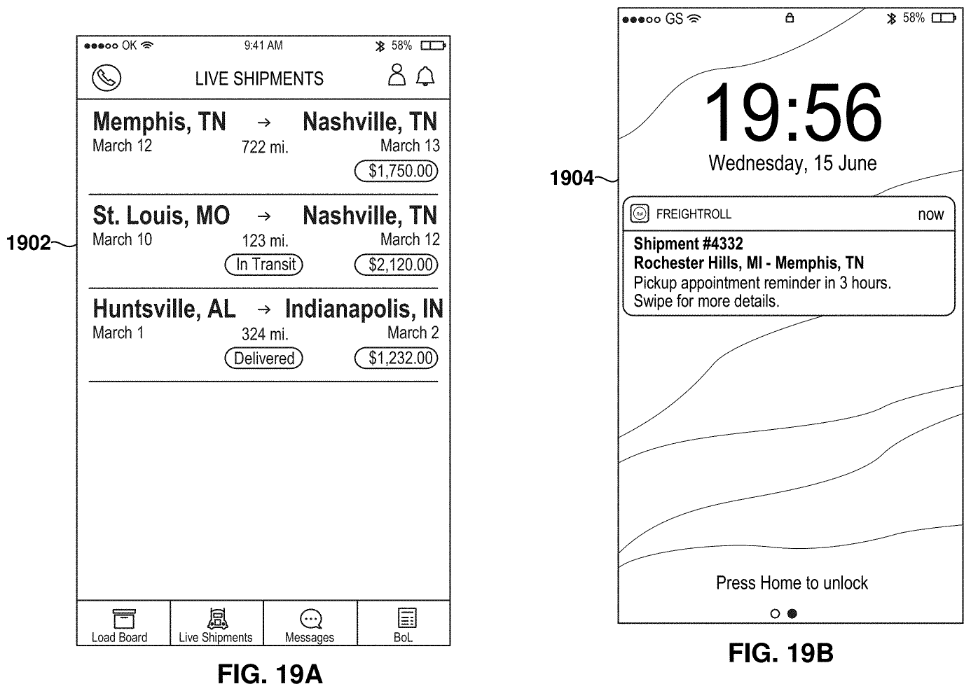

FIG. 19A is a user interface 1902 presenting live shipments, according to some example embodiments. A list of live shipments is presented, where it includes pickup city, drop-off city, pickup date, distance, drop-off date, rate, and a status (optional). The status may be “In Transit,” “Delivered,” “Loading,” “Unloading,” etc.

FIG. 19B illustrates BOL management service notifications 1904 presented on the home screen of the driver's mobile device. The BOL management service generates notifications that may be sent to the different BOL user interfaces.

In some example embodiments, the BOL server sends notifications via the BOL driver app and these notifications may be passed to the operating system on the mobile device. The user is able to configure how the notifications may be presented, filtered, or omitted.

Some example notifications may include: pick up appointments; geofence breach notification; new shipment; detention times; messages from the dispatcher, shipper, consignee, BOL administrator, etc.; BOL alerts; traffic alerts; etc.

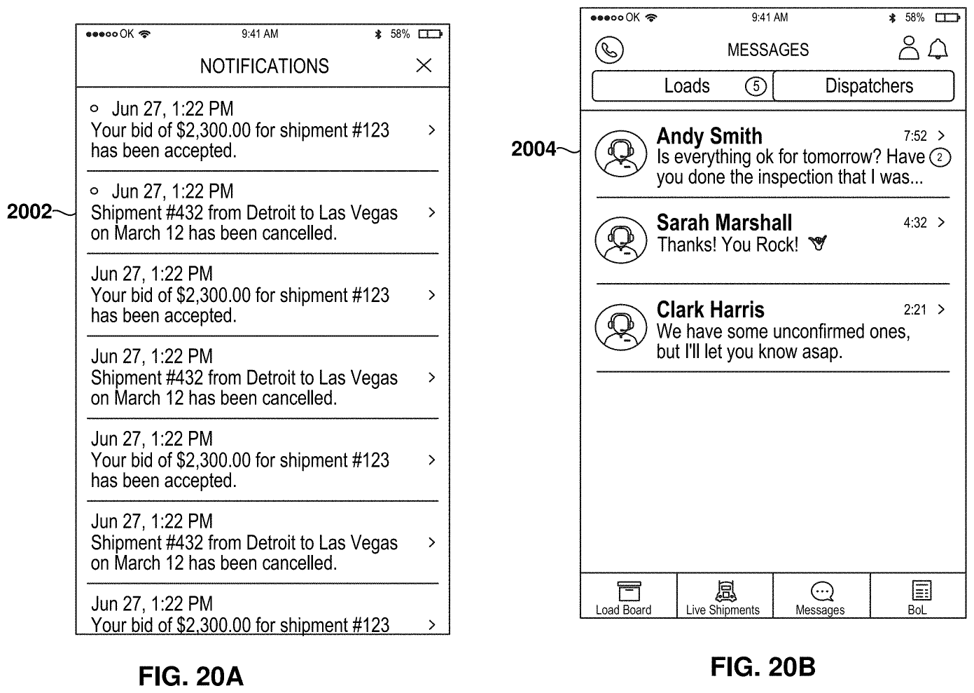

FIG. 20A is a user interface 2002 for listing BOL notifications, according to some example embodiments. A list of notifications is provided on the user interface 2002 and each notification may be selected by the user to access additional information, such as accessing the BOL associated with the notification.

FIG. 20B is a messaging user interface 2004, according to some example embodiments. The messaging user interface 2004 provides in-app messaging for BOL-related activities. Although messaging may be available in the phone, BOL messaging helps the user by separating personal, or other types of communications, from BOL communications. When the driver accesses the BOL messaging option, only BOL-related messages are sent or received, which simplifies the operation of BOL-related activities.

Further, messaging groups may be created automatically for each BOL that include the entities associated with the BOL, such as the shipper, the dispatcher, the driver, and the consignee. This way, the flow of information and messaging related to a particular BOL is easy and quick. Further, messaging is also available to contact the BOL help center.

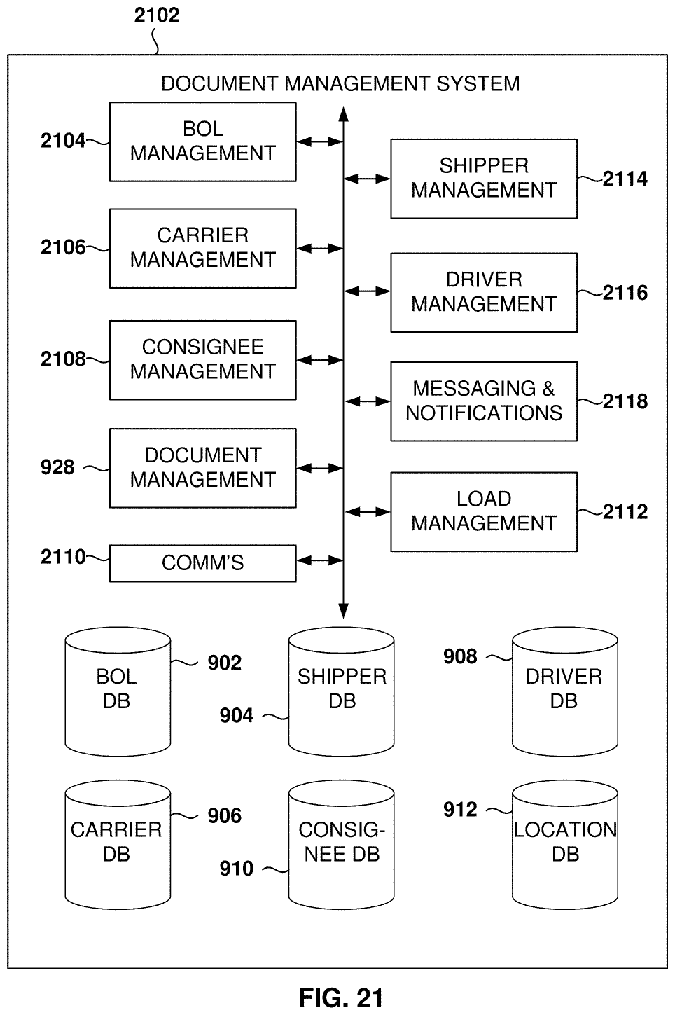

FIG. 21 is a system architecture for the electronic document management system 2102, according to some example embodiments. The document management system 2102 includes BOL management module 2104, shipper management module 2114, carrier management module 2106, driver management module 2116, consignee management module 2108, messaging and notifications module 2118, document management module 928, load management module 2112, communications module 2110, and a plurality of databases. Each of these modules may be implemented in hardware, software or a combination thereof. Further, these modules may be implemented in one machine, or distributed across multiple systems.

The plurality of databases includes a BOL DB 902, a shipper DB 904, a driver DB 908, a carrier DB 906, a consignee DB 910, and a location DB 912.

The BOL management module 2104 initializes the system 2102, coordinates the activities between the other modules in the document management system 2102, and provides management functions for system administrators, which includes providing a user interface for the management and configuration of the system 2102.

The shipper management module 2114 manages shipper-related activities and provides web interfaces to the shippers, such as the BOL web app and the BOL shipper app. The shipper management module 2114 manages shipper accounts, including user logins and passwords. Further, the shipper management module 2114 may generate alerts for shippers based on events associated with shipments.

The carrier management module 2106 manages carrier-related activities and provides web interfaces to the carriers (e.g., dispatcher), such as BOL web app and the BOL carrier app. The carrier management module 2106 manages carrier accounts, including user logins and passwords. Further, the carrier management module 2106 may generate alerts for carriers based on events associated with shipments.

The driver management module 2116 manages driver-related activities and provides web interfaces to the drivers, such as the BOL driver app. The driver management module 2116 manages driver accounts, including user logins and passwords. Further, the driver management module 2116 may generate alerts for drivers based on events associated with shipments.

The consignee management module 2108 manages consignee-related activities and provides web interfaces to the consignees, such as the BOL consignee app. The consignee management module 2108 manages consignee accounts, including user logins and passwords. Further, the consignee management module 2108 may generate alerts for consignees based on events associated with shipments.

The messaging-and-notifications module 2118 provides messaging and notifications for any of the entities in the document management system, such as messaging between the driver and a dispatcher, between the driver and the shipper, a group including shipper, dispatcher, driver, and consignee, etc. Further, the messaging-and-notifications module 2118 may send notifications, such as notifications to the driver's mobile device.

The document-management module 928 manages the formatting and storage of BOL documents and enables each shipper to define their own BOL format, as discussed above.

The load management module 2112 manages the interactions between shippers, drivers, and carriers to identify the status of loads and to assign loads to carriers or drivers within the BOL management service.

The communications module 2110 handles the network communications between the document management system 2102 and the other entities. In some example embodiment, the communications module 2110 provides APIs for outside entities to access the BOL management services. Additionally, the communications module 2110 is configured for accessing APIs provided by the systems utilized by other entities.

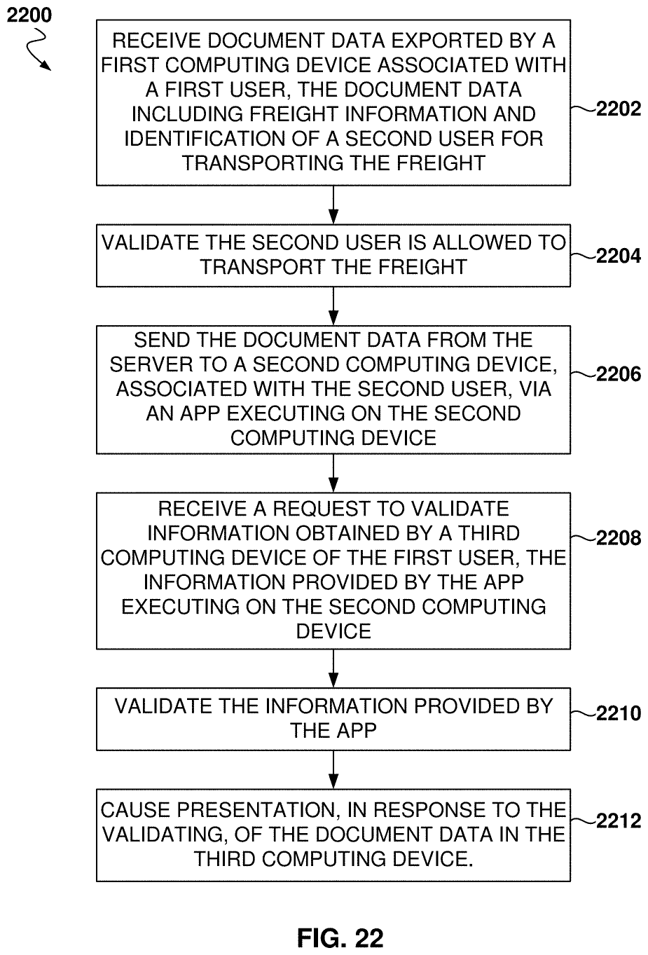

FIG. 22 is a flowchart of a method 2200 for implementing a paperless bill of lading end-to-end system, according to some example embodiments. While the various operations in this flowchart are presented and described sequentially, one of ordinary skill will appreciate that some or all of the operations may be executed in a different order, be combined or omitted, or be executed in parallel.

At operation 2202, a server having one or more processors receives document data exported by a first computing device associated with a first user. The document data includes freight information and identification of a second user for transporting the freight.

From operation 2202, the method 2200 flows to operation 2204 for validating, by the server, that the second user is allowed to transport the freight.

After the validating, at operation 2206, the document data is sent from the server to a second computing device, associated with the second user, via an app executing on the second computing device.

From operation 2206, the method 2200 flows to operation 2208 for receiving, by the server, a request to validate information obtained by a third computing device of the first user, where the information is provided by the app executing on the second computing device.

At operation 2210, the server validates the information provided by the app, and, at operation 2212, the server causes presentation, in response to the validating, of the document data in the third computing device.

Another general aspect is for a system that includes a memory comprising instructions and one or more computer processors. The instructions, when executed by the one or more computer processors, cause the one or more computer processors to perform operations comprising: receiving document data exported by a first computing device associated with a first user, the document data including freight information and identification of a second user for transporting the freight; validating the second user is allowed to transport the freight; after the validating, sending the document data to a second computing device, associated with the second user, via an app executing on the second computing device; receiving a request to validate information obtained by a third computing device of the first user, the information provided by the app executing on the second computing device; validating the information provided by the app; and causing presentation of the document data in the third computing device.

In yet another general aspect, a machine-readable storage medium (e.g., a non-transitory storage medium) includes instructions that, when executed by a machine, cause the machine to perform operations comprising: receiving document data exported by a first computing device associated with a first user, the document data including freight information and identification of a second user for transporting the freight; validating the second user is allowed to transport the freight; after the validating, sending the document data to a second computing device, associated with the second user, via an app executing on the second computing device; receiving a request to validate information obtained by a third computing device of the first user, the information provided by the app executing on the second computing device; validating the information provided by the app; and causing presentation of the document data in the third computing device.

In one example, validating the information provided by the app further comprises receiving, by the server, a request to validate an image captured by a third computing device of the first user; and determining if the image captured by the third computing device corresponds to an element presented in a graphical user interface (GUI) of the app executing on the second computing device.

In one example, receiving the document data comprises importing the document data from an ERP application or a TMS application.

In one example, validating the second user is allowed to transport the freight comprises one or more of checking that information provided by the second user matches information provided by the first user, comparing a Global Positioning System (GPS) location of the second user to a pickup location, checking an Internet Protocol (IP) address of the second computing device, and checking a direction of travel of the second user.

In one example, the method 2200 further comprises enabling access of the document data to a recipient of the freight.

In one example, the method 2200 further comprises capturing, by the app executing on the second computing device, a signature of a recipient of the freight.

In one example, the method 2200 further comprises sending, in response to capturing the signature of the recipient, a notification to the first user that the freight was delivered.

In one example, the method 2200 further comprises storing an immutable version in a database of the document data each time the document data is updated.

In one example, the method 2200 further comprises, in response to receiving the document data, checking if the second user has downloaded the app to the second computing device; and when the second user has not downloaded the app to the second computing device, sending a message to the second user to download the app to the second computing device.

In one example, the method 2200 further comprises detecting that the second user has entered a geofence of a pickup location for the freight; and sending a notification to the first user that the second user has entered the geofence of the pickup location.

In one example, the method 2200 further comprises tracking a location of the second computing device using GPS information captured by the second computing device; and causing presentation in a GUI of a location of the freight based on the tracked location of the second computing device.

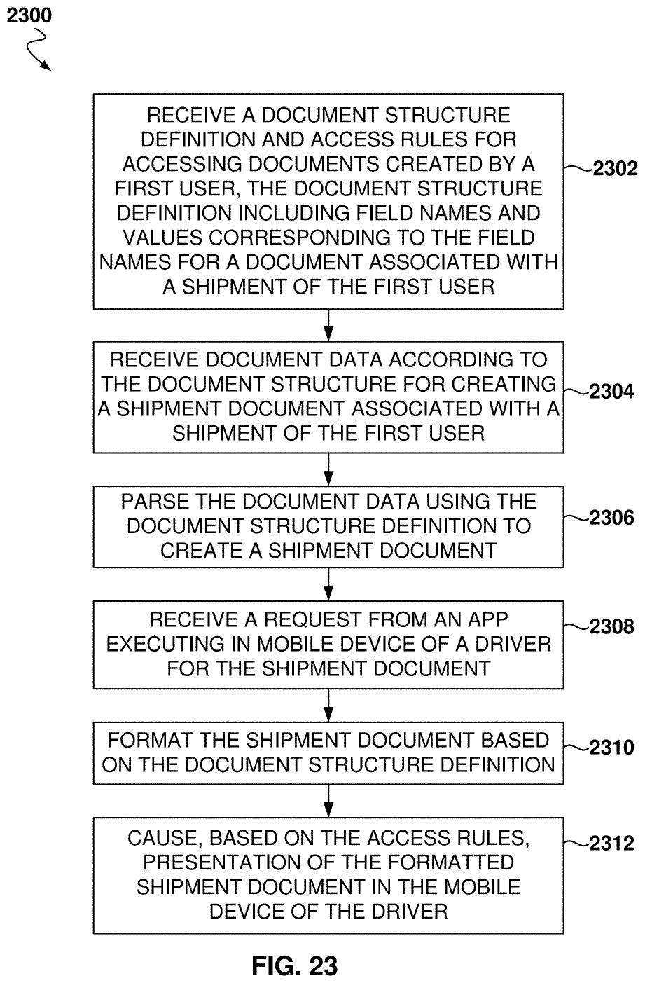

FIG. 23 is a flowchart of a method 2300 for managing the storage of documents, according to some example embodiments. While the various operations in this flowchart are presented and described sequentially, one of ordinary skill will appreciate that some or all of the operations may be executed in a different order, be combined or omitted, or be executed in parallel.

Operation 2302 is for receiving, by a server having one or more processors, a document structure definition and access rules for accessing documents created by a first user. The document structure definition includes field names and values corresponding to the field names for a document associated with a shipment of the first user.

From operation 2302, the method 2300 flows to operation 2304 for receiving, by the server, document data according to the document structure for creating a shipment document associated with a shipment of the first user.

At operation 2306, the server parses the document data using the document structure definition to create a shipment document.

From operation 2306, the method 2300 flows to operation 2308 for receiving, by the server, a request from an app executing in a mobile device of a driver for the shipment document.

At operation 2310, the server formats the shipment document based on the document structure definition, and, at operation 2312, the server causes presentation, based on the access rules, of the formatted shipment document in the mobile device of the driver.

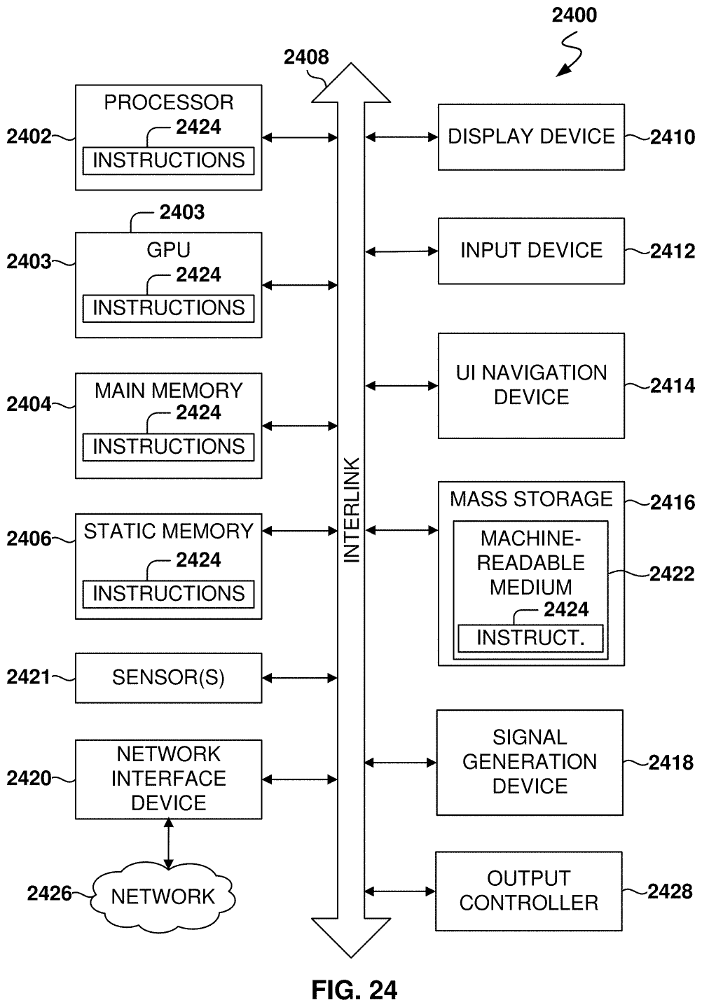

FIG. 24 is a block diagram illustrating an example of a machine 2400 upon or by which one or more example process embodiments described herein may be implemented or controlled. In alternative embodiments, the machine 2400 may operate as a standalone device or may be connected (e.g., networked) to other machines. In a networked deployment, the machine 2400 may operate in the capacity of a server machine, a client machine, or both in server-client network environments. In an example, the machine 2400 may act as a peer machine in a peer-to-peer (P2P) (or other distributed) network environment. Further, while only a single machine 2400 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, by moveable placement of invariant massed particles, etc.) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 2400 may include a hardware processor 2402 (e.g., a central processing unit (CPU), a hardware processor core, or any combination thereof), a graphics processing unit (GPU) 2403, a main memory 2404, and a static memory 2406, some or all of which may communicate with each other via an interlink (e.g., bus) 2408. The machine 2400 may further include a display device 2410, an alphanumeric input device 2412 (e.g., a keyboard), and a user interface (UI) navigation device 2414 (e.g., a mouse). In an example, the display device 2410, alphanumeric input device 2412, and UI navigation device 2414 may be a touchscreen display. The machine 2400 may additionally include a mass storage device (e.g., drive unit) 2416, a signal generation device 2418 (e.g., a speaker), a network interface device 2420, and one or more sensors 2421, such as a Global Positioning System (GPS) sensor, compass, accelerometer, or another sensor. The machine 2400 may include an output controller 2428, such as a serial (e.g., universal serial bus (USB)), parallel, or other wired or wireless (e.g., infrared (IR), near field communication (NFC), etc.) connection to communicate with or control one or more peripheral devices (e.g., a printer, card reader, etc.).

The mass storage device 2416 may include a machine-readable medium 2422 on which is stored one or more sets of data structures or instructions 2424 (e.g., software) embodying or utilized by any one or more of the techniques or functions described herein. The instructions 2424 may also reside, completely or at least partially, within the main memory 2404, within the static memory 2406, within the hardware processor 2402, or within the GPU 2403 during execution thereof by the machine 2400. In an example, one or any combination of the hardware processor 2402, the GPU 2403, the main memory 2404, the static memory 2406, or the mass storage device 2416 may constitute machine-readable media.

While the machine-readable medium 2422 is illustrated as a single medium, the term “machine-readable medium” may include a single medium, or multiple media, (e.g., a centralized or distributed database, and/or associated caches and servers) configured to store the one or more instructions 2424.

The term “machine-readable medium” may include any medium that is capable of storing, encoding, or carrying instructions 2424 for execution by the machine 2400 and that cause the machine 2400 to perform any one or more of the techniques of the present disclosure, or that is capable of storing, encoding, or carrying data structures used by or associated with such instructions 2424. Non-limiting machine-readable medium examples may include solid-state memories, and optical and magnetic media. In an example, a massed machine-readable medium comprises a machine-readable medium 2422 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 2424 may further be transmitted or received over a communications network 2426 using a transmission medium via the network interface device 2420.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, by a server having one or more processors, document data exported by a first computing device associated with a first user, the document data including freight information and identification of a second user for transporting a freight;
validating, by the server, the second user is allowed to transport the freight;
after the validating, sending the document data from the server to a second computing device, associated with the second user, via an app executing on the second computing device;
receiving, by the server, a request to validate information obtained by a third computing device of the first user, the information provided by the app executing on the second computing device;
validating, by the server, the information provided by the app; and
causing presentation, by the server and in response to the validating, of the document data in the third computing device.

2. The method as recited in claim 1, wherein validating the information provided by the app further comprises:
receiving, by the server, a request to validate an image captured by a third computing device of the first user; and
determining if the image captured by the third computing device corresponds to an element presented in a graphical user interface (GUI) of the app executing on the second computing device.

3. The method as recited in claim 1, wherein receiving the document data comprises:
importing the document data from an Enterprise Resource Management (ERP) application or a Transportation Management System (TMS) application.

4. The method as recited in claim 1, wherein validating the second user is allowed to transport the freight comprises one or more of checking that information provided by the second user matches information provided by the first user, comparing a Global Positioning System (GPS) location of the second user to a pickup location, checking an Internet Protocol (IP) address of the second computing device, and checking a direction of travel of the second user.

5. The method as recited in claim 1, further comprising:
enabling, by the server, access of the document data to a recipient of the freight.

6. The method as recited in claim 1, further comprising:
capturing, by the app executing on the second computing device, a signature of a recipient of the freight.

7. The method as recited in claim 6, further comprising:
sending, in response to capturing the signature of the recipient, a notification to the first user that the freight was delivered.

8. The method as recited in claim 1, further comprising:
storing an immutable version in a database of the document data each time the document data is updated.

9. The method as recited in claim 1, further comprising:
in response to receiving the document data, checking if the second user has downloaded the app to the second computing device; and
when the second user has not downloaded the app to the second computing device, sending a message to the second user to download the app to the second computing device.

10. The method as recited in claim 1, further comprising:
detecting that the second user has entered a geofence of a pickup location for the freight; and
sending a notification to the first user that the second user has entered the geofence of the pickup location.

11. The method as recited in claim 1, further comprising:
tracking a location of the second computing device using GPS information captured by the second computing device; and
causing presentation in a GUI of a location of the freight based on the tracked location of the second computing device.

12. A system comprising:
a memory comprising instructions; and
one or more computer processors, wherein the instructions, when executed by the one or more computer processors, cause the one or more computer processors to perform operations comprising:
receiving document data exported by a first computing device associated with a first user, the document data including freight information and identification of a second user for transporting a freight;
validating the second user is allowed to transport the freight;
after the validating, sending the document data to a second computing device, associated with the second user, via an app executing on the second computing device;
receiving a request to validate information obtained by a third computing device of the first user, the information provided by the app executing on the second computing device;
validating the information provided by the app; and
causing presentation of the document data in the third computing device.

13. The system as recited in claim 12, wherein validating the information provided by the app further comprises:
receiving a request to validate an image captured by the third computing device of the first user; and
determining if the image captured by the third computing device corresponds to an element presented in a graphical user interface (GUI) of the app executing on the second computing device.

14. The system as recited in claim 12, wherein receiving the document data comprises:
importing the document data from an Enterprise Resource Management (ERP) application or a Transportation Management System (TMS) application.

15. The system as recited in claim 12, wherein validating the second user is allowed to transport the freight comprises one or more of checking that information provided by the second user matches information provided by the first user, comparing a Global Positioning System (GPS) location of the second user to a pickup location, checking an Internet Protocol (IP) address of the second computing device, and checking a direction of travel of the second user.

16. The system as recited in claim 12, wherein the instructions further cause the one or more computer processors to perform operations comprising:
capturing, by the app executing on the second computing device, a signature of a recipient of the freight; and
sending, in response to capturing the signature of the recipient, a notification to the first user that the freight was delivered.

17. A non-transitory machine-readable storage medium including instructions that, when executed by a machine, cause the machine to perform operations comprising:
receiving document data exported by a first computing device associated with a first user, the document data including freight information and identification of a second user for transporting a freight;
validating the second user is allowed to transport the freight;
after the validating, sending the document data to a second computing device, associated with the second user, via an app executing on the second computing device;
receiving a request to validate information obtained by a third computing device of the first user, the information provided by the app executing on the second computing device;
validating the information provided by the app; and
causing presentation of the document data in the third computing device.

18. The non-transitory machine-readable storage medium as recited in claim 17, wherein validating the information provided by the app further comprises:
receiving a request to validate an image captured by a third computing device of the first user; and
determining if the image captured by the third computing device corresponds to an element presented in a graphical user interface (GUI) of the app executing on the second computing device.

19. The non-transitory machine-readable storage medium as recited in claim 17, wherein receiving the document data comprises:
importing the document data from an Enterprise Resource Management (ERP) application or a Transportation Management System (TMS) application.

20. The non-transitory machine-readable storage medium as recited in claim 17, wherein validating the second user is allowed to transport the freight comprises one or more of checking that information provided by the second user matches information provided by the first user, comparing a Global Positioning System (GPS) location of the second user to a pickup location, checking an Internet Protocol (IP) address of the second computing device, and checking a direction of travel of the second user.
